(19) United States
(12) Patent Application Publication
(10) Pub. No.: US 2022/0414434 A1
(43) Pub. Date: Dec. 29, 2022

(54) IMPLEMENTING NEURAL NETWORKS THAT INCLUDE CONNECTIVITY NEURAL NETWORK LAYERS USING SYNAPTIC CONNECTIVITY

(71) Applicant: X Development LLC, Mountain View, CA (US)

(72) Inventor: Lam Thanh Nguyen, Mountain View, CA (US)

(21) Appl. No.: 17/362,747

(22) Filed: Jun. 29, 2021

(51) Int. Cl. G06N 3/06; G06N 3/08

(52) U.S. Cl. CPC G06N 3/061; G06N 3/08

(57) ABSTRACT

Methods, systems, and apparatus, including computer programs encoded on a computer storage medium, for implementing connectivity neural network layers. One of the methods includes processing a network input using a neural network to generate a network output, comprising: generating a layer input to a connectivity layer of the neural network based on the network input, wherein the layer input to the connectivity layer comprises a plurality of input values arranged in a plurality of input channels; processing the layer input using the connectivity layer to generate a layer output comprising a plurality of output values arranged in a plurality of output channels; processing the plurality of output channels of the connectivity layer using a brain emulation subnetwork of the neural network to generate a brain emulation subnetwork output; and generating the network output based on the brain emulation subnetwork output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for implementing neural networks that includes a brain emulation subnetwork whose parameters have been determined according to the synaptic connectivity between neurons in the brain of a biological organism, e.g., a fly. This specification also describes systems for training a neural network that includes a brain emulation subnetwork.

For example, the parameters of a brain emulation subnetwork can be determined using a synaptic connectivity graph. A synaptic connectivity graph refers to a graph representing the structure of synaptic connections between neurons in the brain of a biological organism, e.g., a fly. For example, the synaptic connectivity graph can be generated by processing a synaptic resolution image of the brain of a biological organism.

For convenience, throughout this specification, an artificial neural network layer whose parameters have been determined using synaptic connectivity is called a “brain emulation” neural network layer. For convenience and to distinguish from brain emulation neural network layers, this specification refers to neural network layers whose parameters have not been determined using synaptic connectivity as “trained” neural network layers. The parameters of a trained neural network layer can be determined using supervised learning (e.g., backpropagation and gradient descent), unsupervised learning, or reinforcement learning, to name just a few examples. In some implementations, the parameters of a brain emulation neural network layer of a neural network are also updated during training of the neural network. That is, initial values for the parameters of the brain emulation neural network layer can be determined using synaptic connectivity, and those initial values can be updated using machine learning techniques.

In this specification, an artificial neural network having at least one brain emulation neural network layer is called a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

Similarly, in this specification, a subnetwork of an artificial neural network that includes at least one brain emulation neural network layer is called a “brain emulation” subnetwork, while other subnetworks of the neural network that do not include any brain emulation neural network layers are called “trained” subnetworks. As described above, this distinction is made for convenience, and in some implementations the parameters of a brain emulation subnetwork can also be updated during training of the neural network.

A brain emulation subnetwork can be inserted at any location within the architecture of a neural network. For example, the brain emulation neural network can be inserted following an encoder subnetwork of the neural network, and before a decoder subnetwork of the neural network. As a particular example, the brain emulation subnetwork can be inserted at a bottleneck of the neural network. This is described in more detail below with reference to FIG. 1.

In this specification, the trained neural network layer immediately preceding a brain emulation subnetwork in the architecture of a neural network, and the trained neural network layer immediately following the brain emulation subnetwork in the architecture of the neural network, are called “connectivity” neural network layers. In some implementations, for each of one or more connectivity neural network layers of a neural network, the connectivity neural network layer divides the layer input to the connectivity neural network layer into multiple different channels, and processes each channel using one or more sub-layers of the connectivity neural network layer. Each sub-layer of a connectivity neural network layer can process a proper subset of the channels of the layer input to generate a respective channel of the layer output of the connectivity neural network layer. This process can significantly reduce the number of computations executed by the connectivity neural network layer compared to a fully-connected neural network layer. This process is described in more detail below with reference to FIG. 2.

In this specification, a channel of a first array of values is another array of values that includes a proper subset of the values of the first array. For example, if the first array is an N-dimensional array of values, then a channel of the first array can be an array that has at most N dimensions. In some implementations, a channel of an array includes a contiguous proper subset of the values of the array, i.e., each value in the channel is adjacent, within the array, to at least one other value in the channel.

Particular embodiments of the subject matter described in this specification can be implemented so as to realize one or more of the following advantages.

The systems described in this specification can train and implement a neural network that includes a brain emulation subnetwork. As described in this specification, neural networks that include brain emulation subnetworks can achieve a higher performance (e.g., in terms of prediction accuracy), than other neural networks of an equivalent size (e.g., in terms of number of parameters).

In some implementations described in this specification, the brain emulation subnetwork of a neural network can have significantly fewer parameters than the trained subnetworks of the neural network. For example, a brain emulation neural network can include 100 or 1000 parameters, while the trained subnetworks of the neural network include hundreds of thousands or millions of parameters. Thus, inserting a brain emulation subnetwork into the architecture of a neural network can significantly improve the performance of the neural network while only negligibly increasing the number of computations or the amount of time required to execute the neural network. Therefore, using techniques described in this specification, a system can implement a highly efficient, low-latency, and low-power-consuming neural network.

The presence of a brain emulation subnetwork in the architecture of a neural network can further significantly reduce the amount of time required to train the neural network. That is, the amount of time required to train a neural network that includes a brain emulation subnetwork to achieve a particular performance can be significantly less than the time required to train another neural network that includes the same trained subnetworks but does not include a brain emulation subnetwork. For example, inserting a brain emulation subnetwork into the architecture of a neural network can reduce the amount of time required to achieve a particular performance by 100×, 1000×, or 10,000×.

In particular, in some implementations described herein, inserting a brain emulation subnetwork at a bottleneck of the architecture of a neural network can be particularly effective at improving the performance and/or training of the neural network. At the bottleneck of the network architecture, the hidden representation of the network input to the neural network is the most “dense” compared to other hidden representations of the network input, i.e., the information in the network input is encoded into the smallest size of all the hidden representations. In some implementations, a brain emulation subnetwork can be more effective at processing highly dense and information-rich representations than standard neural network layers, and can extract the maximal amount of information from the dense hidden representation in order to accomplish the machine learning task for which the neural network is configured.

As described above, in some implementations a connectivity neural network layer of a brain emulation neural network can divide its layer input into multiple different channels. Then, for each of multiple sub-layers of the connectivity neural network layer, the sub-layer can process a proper subset of the channels of the layer input to generate a respective channel of the layer output of the connectivity neural network layer. Such a connectivity neural network layer can be significantly more efficient, in terms of time, memory, and computations, than a fully-connected neural network layer would be at the same location in the architecture of the brain emulation neural network.

These efficiency gains can be especially important in low-resource or low-memory environments, e.g., on mobile devices or other edge devices. Additionally, these efficiency gains can be especially important in situations in which the brain emulation neural network is continuously processing network inputs, e.g., in an application that continuously processes input audio data to determine whether a “wakeup” phrase has been spoken by a user.

The systems described in this specification can implement a brain emulation neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation neural networks can share this capacity to effectively solve tasks. In particular, compared to other neural networks, e.g., with manually specified neural network architectures, brain emulation neural networks can require less training data, fewer training iterations, or both, to effectively solve certain tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates example neural network computing systems.

FIG. 2 illustrates an example block of neural network layers that includes example connectivity neural network layers and an example brain emulation subnetwork.

FIG. 3A illustrates another example neural network computing system.

FIG. 3B illustrates an example weight matrix of a brain emulation neural network layer determined using synaptic connectivity.

FIG. 4A illustrates an example of generating a brain emulation neural network based on a synaptic resolution image of the brain of a biological organism.

FIG. 4B shows an example data flow for generating a synaptic connectivity graph and a brain emulation neural network based on the brain of a biological organism.

FIG. 5 shows an example architecture mapping system.

FIG. 6 illustrates an example graph and an example sub-graph.

FIG. 7A is a flow diagram of an example process for executing a neural network that includes a connectivity layer and a brain emulation subnetwork.

FIG. 7B is a flow diagram of an example process for executing a neural network that includes an encoder subnetwork, a brain emulation subnetwork, and a decoder subnetwork.

FIG. 8 is a flow diagram of an example process for generating a brain emulation neural network.

FIG. 9 is a flow diagram of an example process for determining an artificial neural network architecture corresponding to a sub-graph of a synaptic connectivity graph.

FIG. 10 is a block diagram of an example architecture selection system.

FIG. 11 is a block diagram of an example computer system.

Like reference numbers and designations in the various drawings indicate like elements.

### DETAILED DESCRIPTION

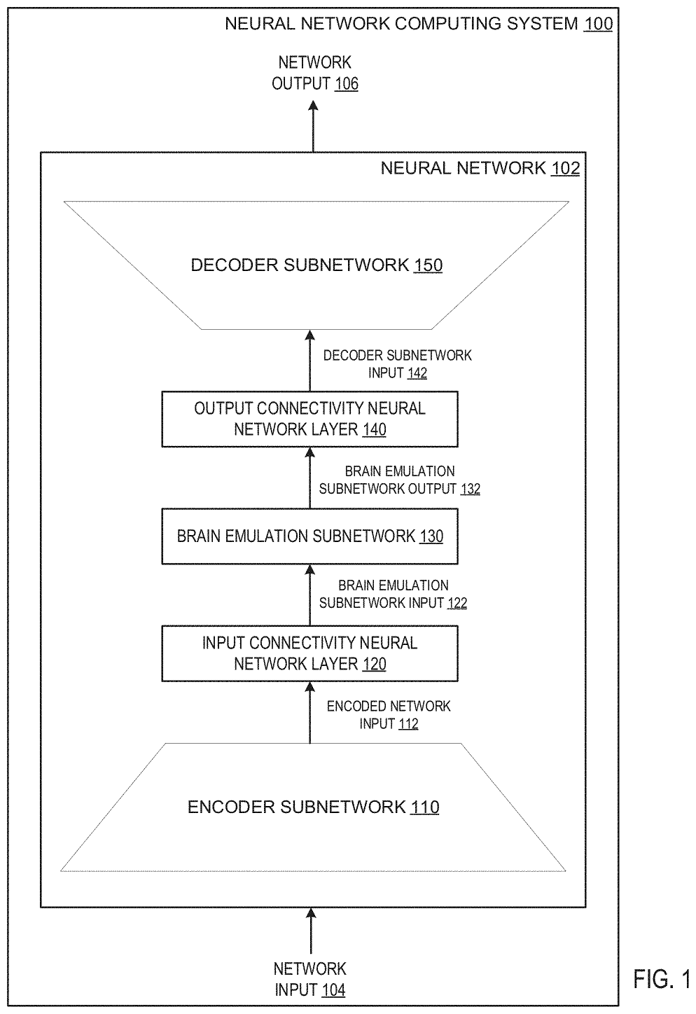

FIG. 1 shows an example neural network computing system 100. The neural network computing system 100 is an example of a system implemented as computer programs on one or more computers in one or more locations in which the systems, components, and techniques described below are implemented.

The neural network computing system 100 includes a neural network 102. The neural network 102 includes an encoder subnetwork 110, an input connectivity neural network layer 120, a brain emulation subnetwork 130, an output connectivity neural network layer 140, and a decoder subnetwork 150.

The neural network 102 is configured to process a network input 104 to generate a network output 106 for a particular machine learning task. The network input 104 for the neural network 102 can be any kind of digital data input, and the network output 106 for the neural network 102 can be any kind of score, classification, or regression output based on the input. That is, the neural network 102 can be configured for any appropriate machine learning tasks; example tasks are discussed below.

The encoder subnetwork 110 of the neural network 102 is configured to process the network input 104 to encode the network input 104, generating an encoded network input 112. The encoded network input 112 is an embedding of the network input 104.

In this specification, an encoder subnetwork of a neural network is a subnetwork that includes one or more trained neural network layers and that, in some implementations, reduces the size of a hidden representation of the network input to the neural network. That is, an encoder subnetwork is configured to process an encoder subnetwork input (generated from the network input to the neural network) and to generate an encoder subnetwork output, where in some implementations, the encoder subnetwork output has a smaller size (e.g., as measured by the dimensionality of the encoder subnetwork output) than the encoder subnetwork input. Thus, in the example depicted in FIG. 1, the encoded network input 112 has a smaller size than the network input 104.

In some implementations, the sequence of neural network layers in the encoder subnetwork 110 each decrease the size of the hidden representation of the network input 104. In some other implementations, one or more neural network layers of the encoder subnetwork 110 increase the size of the hidden representation or leave the size constant, while still satisfying the requirement that the encoded network input 112 is smaller than the network input 104.

In some implementations, in addition to one or more trained neural network layers, the encoder subnetwork 110 also includes one or more brain emulation neural network layers. In some other implementations, the encoder subnetwork 110 is a trained subnetwork, i.e., does not include any brain emulation neural network layers.

The input connectivity neural network layer 120 is a trained neural network layer directly preceding the brain emulation subnetwork 130 of the neural network 102. The input connectivity neural network layer 120 is configured to process the encoded network input 112 and to generate a brain emulation subnetwork input 122 for the brain emulation subnetwork 130.

The brain emulation subnetwork input 122 can have a predefined dimensionality, e.g., a dimensionality required by the brain emulation neural network architecture of the brain emulation subnetwork 130 determined using synaptic connectivity. The input connectivity neural network layer 120 can be configured to project the encoded network input 112 to the predefined dimensionality of the brain emulation subnetwork input 122. That is, the input connectivity neural network layer 120 can be configured to map the output of the encoder subnetwork 110 to the required dimensionality for processing by the brain emulation subnetwork 130.

After the neural network 102 has been trained, the input connectivity neural network layer 120 is configured to generate a brain emulation subnetwork input 122 that is optimized for the brain emulation subnetwork 130, e.g., that encodes maximal information from the network input 104 that is usable by the brain emulation subnetwork 130.

In some implementations, the input connectivity neural network layer 120 is a fully-connected neural network layer. That is, each element of the encoded network input 112 can be used to generate each element of the brain emulation subnetwork input 122.

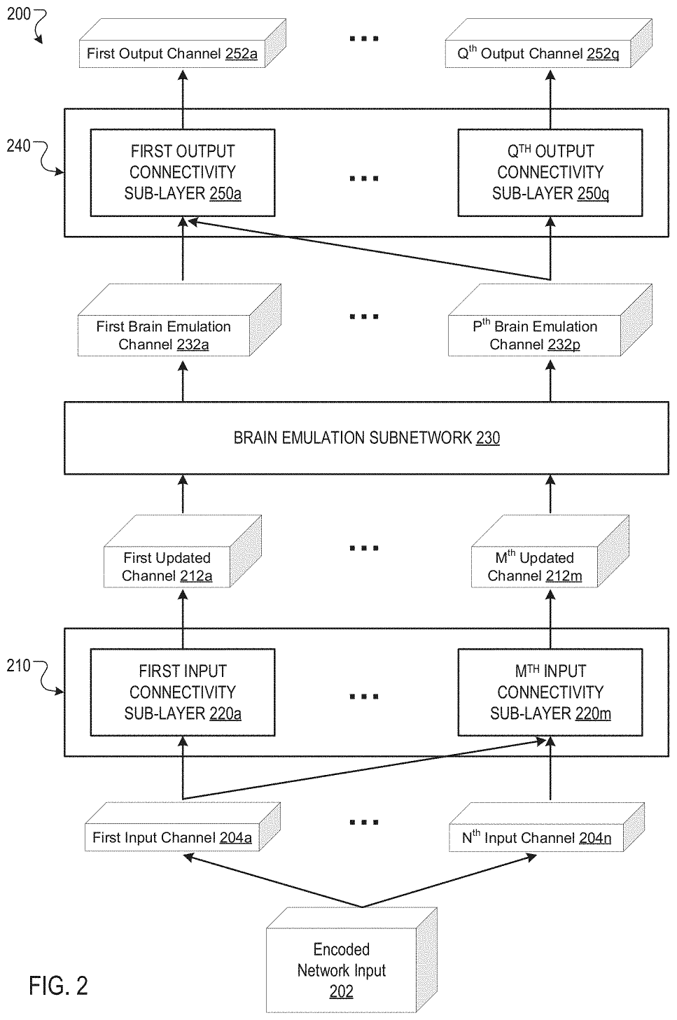

In some other implementations, the input connectivity neural network layer 120 divides the encoded network input 112 into multiple channels, and generates respective channels of the brain emulation subnetwork input 122 by processing respective proper subsets of the channels of the encoded network input 112. That is, each element of the brain emulation subnetwork input 112 can be generated from a proper subset of the elements of the encoded network input 112. Typically, such a connectivity neural network layer has fewer trained parameters than a fully-connected neural network, thus requiring less time to train and execute at inference. This process is described in more detail below with reference to FIG. 2.

In other words, the output of a connectivity neural network layer (e.g., the brain emulation subnetwork input 122 generated by the input connectivity neural network layer 120) can include multiple different components, and the connectivity neural network layer can generate each component by processing only a respective proper subset of the input to the connectivity neural network layer (e.g., the encoded network input 112).

The brain emulation subnetwork 130 is configured to process the brain emulation subnetwork input 122 and to generate a brain emulation subnetwork output 132, which can be processed by subsequent neural network layers in the neural network 102. The brain emulation subnetwork input 122 and the brain emulation subnetwork output 132 may be represented in any appropriate numerical format, for example, as vectors or as matrices.

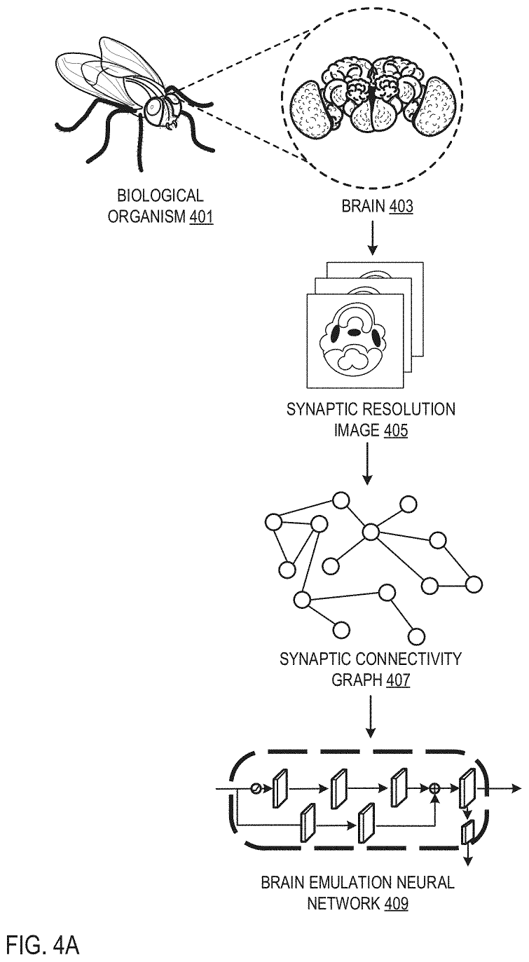

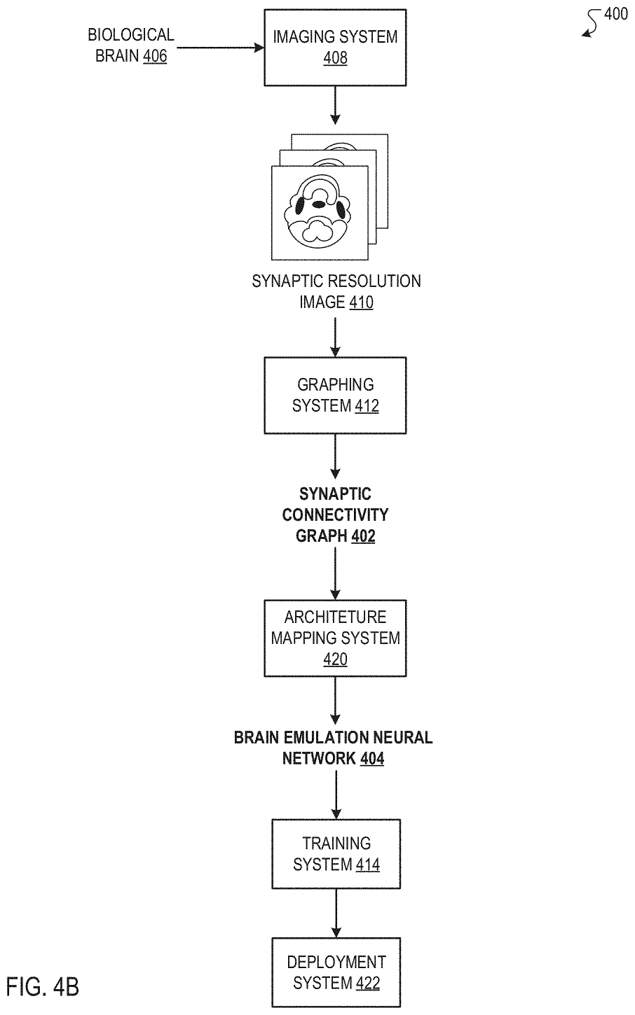

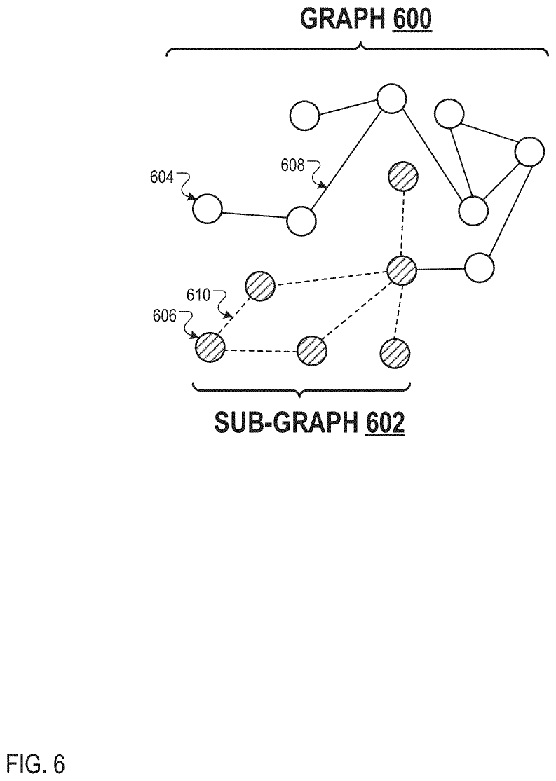

The brain emulation subnetwork 130 can have an architecture that is based on a synaptic connectivity graph representing synaptic connectivity between neurons in the brain of a biological organism. An example process for determining a network architecture using a synaptic connectivity graph is described below with respect to FIG. 4A. In some implementations, the architecture of the brain emulation subnetwork 130 can be specified by the synaptic connectivity between neurons of a particular type in the brain, e.g., neurons from the visual system or the olfactory system. This process is described in more detail below with reference to FIG. 6.

The output connectivity neural network layer 140 is a trained neural network layer directly following the brain emulation subnetwork 130 of the neural network 102. The output connectivity neural network layer 140 is configured to process the brain emulation subnetwork output 132 and to generate a decoder subnetwork input 142 for the decoder subnetwork 150. After the neural network 102 has been trained, the output connectivity neural network layer 140 is configured to generate a decoder subnetwork input 142 that is optimized for the decoder subnetwork 150, e.g., that encodes maximal information from the brain emulation subnetwork output 132 that is usable by the decoder subnetwork 150.

The brain emulation subnetwork 130 can be configured to generate a brain emulation subnetwork output 132 that has a predefined dimensionality, e.g., a dimensionality required by the brain emulation neural network architecture of the brain emulation subnetwork 130 determined using synaptic connectivity. The output connectivity neural network layer 140 can be configured to project the brain emulation subnetwork output 132 from the predefined dimensionality of the brain emulation subnetwork output 132 to a dimensionality that is required by the decoder subnetwork 150. That is, the output connectivity neural network layer 140 can be configured to map the output of the brain emulation subnetwork 130 to the required dimensionality for processing by the decoder subnetwork 150.

In some implementations, the output connectivity neural network layer 140 is a fully-connected neural network layer. In some other implementations, the output connectivity neural network layer 140 divides the brain emulation subnetwork output 132 into multiple channels, and generates respective channels of the decoder subnetwork input 142 by processing respective proper subsets of the channels of the brain emulation subnetwork output 132. Generally, the input connectivity neural network layer 120 and the output connectivity neural network layer 140 can be the same type of neural network layer (e.g., both fully-connected neural network layers) or different types of neural network layer.

The decoder subnetwork 150 of the neural network 102 is configured to process the decoder subnetwork input 142 to generate the network output 106.

In this specification, a decoder subnetwork of a neural network is a subnetwork that includes one or more trained neural network layers and that, in some implementations, increases the size of a hidden representation of the network input to the neural network. That is, a decoder subnetwork is configured to process a decoder subnetwork input (generated from the network input to the neural network) and to generate a decoder subnetwork output, where in some implementations, the decoder subnetwork output has a larger size (e.g., as measured by the number of parameters) than the decoder subnetwork input. Thus, in the example depicted in FIG. 1, the network output 106 has a larger size than the decoder subnetwork output 142.

In some implementations, the sequence of neural network layers in the decoder subnetwork 150 each increase the size of the hidden representation of the network input 104. In some other implementations, one or more neural network layers of the decoder subnetwork 150 decrease the size of the hidden representation or leave the size constant, while still satisfying the requirement that the network output 106 is larger than the decoder subnetwork input 142.

In some implementations, in addition to one or more trained neural network layers, the decoder subnetwork 150 also includes one or more brain emulation neural network layers. In some other implementations, the decoder subnetwork 150 is a trained subnetwork, i.e., does not include any brain emulation neural network layers.

In some implementations, the brain emulation subnetwork input 122 is at a “bottleneck” of the neural network 102. In this specification, a bottleneck of a neural network is a location in the architecture of the neural network at which the hidden representation of the network input to the neural network is smallest. That is, the brain emulation subnetwork input 122 (or the brain emulation subnetwork output 132, in some implementations in which the brain emulation subnetwork 130 itself changes the size of the hidden representation) can be the smallest hidden representation of the network input 104, of all hidden representations generated by respective neural network layers of the neural network 102.

The neural network 102 can have any appropriate network architecture. For example, the neural network 102 can be an autoencoder neural network, where the encoder subnetwork 110 is the encoder of the autoencoder and the decoder subnetwork 150 is the decoder of the autoencoder. That is, the neural network 102 can be an autoencoder neural network that is configured to generate an embedding of the network input 104 (e.g., using the encoder subnetwork 110, where the embedding is the encoded network input 112) and then process the embedding to reconstruct the network input (e.g., using the decoder subnetwork 150, where the network output 106 is a predicted reconstruction of the network input 104). As a particular example, the neural network 102 can be a variational autoencoder that models the latent space of the generated embeddings using a mixture of distributions instead of a fixed vector.

For example, to train the autoencoder neural network, a training system can evaluate an objective function that measures an error between: (i) the network input 104, and (ii) the predicted reconstruction 106 of the network input 104. The training system can then update at least some of the neural network parameters of the neural network 102 using respective gradients of the objective function.

Autoencoder neural networks can be used for many different machine learning tasks, For example, after training, the encoder subnetwork of an autoencoder neural network can be used to generate compact embeddings of network inputs 104 (e.g., embeddings of image data, audio data, video data, and so on). Because the encoder subnetwork 110 has been trained to generate an encoded network input 112 that can be used by the decoder subnetwork 150 to reconstruct the network input 104, the encoder subnetwork 110 can be configured to incorporate a maximal amount of information about the network input 104 into the encoded network input 112, making the encoded network input 112 a rich representation of the information in the network input 104. These embeddings 112 can be used by downstream systems to perform machine learning tasks. In some implementations, the same encoded network input 112 can be used by multiple different downstream systems to perform multiple different respective machine learning tasks.

As another example, the neural network 102 can be a “U-net” neural network. In this specification, a U-net neural network is a neural network that is configured to process multiple versions of a network input 104, where each version has a different size (e.g., if the network input 104 is an image, each version can be the same image at different resolutions). U-net neural network are discussed in more detail in “U-Net: Convolutional Networks for Biomedical Image Segmentation”, Ronneberger et al., arxiv: 1505.04597. In this example, the brain emulation subnetwork 130 can be inserted at the lowest level of the U-net architecture, i.e., at the location in the architecture where the smallest version of the network input is processed. As a particular example, the brain emulation subnetwork 130 can be inserted at the location in the architecture when a hidden representation of the smallest version of the network input is smallest, i.e., smaller than all other hidden representations of the smallest version of the network input.

In some U-net neural network architectures, the encoder subnetwork 110 can include a sequence of multiple encoder blocks. Each encoder block can be configured to process a respective encoder block input to generate a respective encoder block output. For each encoder block, the spatial resolution of the encoder block output can be lower than the spatial resolution of the encoder block input. For each encoder block that is after an initial encoder block in the sequence of encoder blocks, the encoder block input can include a previous encoder block output of a previous encoder block in the sequence of encoder blocks.

Similarly, the decoder subnetwork 150 can include a sequence of multiple decoder blocks. Each decoder block can be configured to process a respective decoder block input to generate a respective decoder block output. For each decoder block, the spatial resolution of the decoder block output can be greater than the spatial resolution of the decoder block input. For each decoder block that is after an initial decoder block in the sequence of decoder blocks, the decoder block input can include (i) an intermediate output of a respective encoder block, and (ii) a previous decoder block output of a previous decoder block.

As a particular example, each encoder block and each decoder block can include one or more two-dimensional convolutional neural network layers, one or more three-dimensional convolutional neural network layers, or both.

As another example, the neural network 102 can be an “Inception” neural network that includes one or more Inception blocks. In this specification, an Inception block is a block of multiple different convolutional neural network layers that are each configured to process a hidden representation of the network input 104 using a respective different convolutional kernel. For example, the convolutional neural network layers in a given Inception block can process the hidden representation of the network input 104 using convolutional kernels of different sizes. The Inception block can then combine the respective outputs of the multiple convolutional neural network layers to generate a block output, e.g., using concatenation. Inception neural networks are described in more detail in “Going Deeper with Convolutions”, Szegedy et al., arxiv: 1409.4842. In this example, the brain emulation subnetwork 130 can be inserted before a sequence of one or more Inception blocks, as Inception blocks can, in some implementations, increase a size of the hidden representation of the network input 104. As a particular example, the encoder subnetwork 110 can be at the “stem” of the Inception neural network (i.e., at a location in the architecture that is after a sequence of one or more convolutional neural network layers that are not part of an Inception block, and before a sequence of one or more Inception blocks) and the decoder subnetwork 150 can include the sequence of one or more Inception blocks.

FIG. 2 illustrates an example block 200 of neural network layers that includes example connectivity neural network layers 210 and 240 and an example brain emulation subnetwork 230.

As described above, the connectivity neural network layers 210 and 240 immediately precede and follow, respectively, the brain emulation subnetwork 230 in the network architecture of a neural network.

In some implementations, as described above, the brain emulation subnetwork 230 can be at a location in the network architecture after an encoder subnetwork of the neural network and before a decoder subnetwork of the neural network. As a particular example, the brain emulation subnetwork 230 can be the brain emulation subnetwork 130 described above with reference to FIG. 1. Generally, the brain emulation subnetwork 230 can be at any appropriate location in the network architecture of the neural network, e.g., before an encoder subnetwork of the neural network, after a decoder subnetwork of the neural network, in a “flat” portion of the network architecture (i.e., a portion of the network architecture where the size of the hidden representations of the network input to the neural network stays constant), and so on.

The block 200 of neural network layers is configured to receive as input an encoder network input 202, which has been generated by one or more trained neural network layers preceding the block 200 in the network architecture of the neural network.

Before processing the encoded network input 202 using the input connectivity neural network layer 210, the neural network divides the encoded network input 202 into N different input channels 204a-n, N>1. Although the encoded network input 202 is depicted as three-dimensional in FIG. 2, generally the input to the block 200 can have any dimensionality. Generally, each element of the encoded network input 202 is included in exactly one input channel 204a-n.

In some implementations, each input channel 204a-n has a lower dimensionality than the encoded network input 202. For example, each input channel 204a-n can correspond to a respective different index along a particular dimension of the encoded network input 202, and includes every element of the encoded network input 202 having the respective index in the particular dimension. As a particular example, if the encoded network input 202 has size L₁×W₁, then the neural network can divide the encoded network input into L₁ input channels 204a-n (i.e., N=L₁), where each input channel has size W₁. As another particular example, if the encoded network input 202 has size L₁×W₁×H₁, then the neural network can divide the encoded network input into H₁ input channels 204a-n (i.e., N=H₁), where each input channel 204a-n has size L₁×W₁.

In some other implementations, each input channel 204a-n has the same dimensionality as the encoded network input 202. For example, if the encoded network input 202 is two-dimensional having size 100×100, then the neural network can divide the encoded network input into 100 input channels 204a-n each having size 10×10. As another example, if the encoded network input 202 is three-dimensional having size 100×100×100, then the neural network can divide the encoded network input into 1000 input channels 204a-n each having size 10×10×10.

Before training the neural network, a training system can randomly assign each position of the encoded network input 202 to one or more respective input channels 204a-n. Then, each time the neural network is executed, the neural network can assign the element at each position to the one or more input channels 204a-n corresponding to the position. That is, in some implementations, each element in the encoded network input 202 is included in exactly one input channel 204a-n, while in some other implementations, some or all of the elements in the encoded network input 202 are included in more than one input channel 204a-n.

For example, the input channels 204a-n can “overlap” each other within the encoded network input 202. As a particular example, if the encoded network input 202 is a one-dimensional input having ten elements, then the encoded network input 202 can be divided into four input channels 204a-n each having four elements, where elements 1-4 are assigned to the first input channel, elements 3-6 are assigned to the second input channel, elements 5-8 are assigned to the third input channel, and elements 7-10 are assigned to the fourth input channel.

In some implementations, each of the input channel 204a-n has the same size. In some other implementations, different input channels 204a-n can have different sizes.

The input connectivity neural network layer 210 includes M different sub-layers 220a-n that are each configured to process a respective proper subset of the input channels 204a-n and to generate a respective updated channel 212a-m. That is, each input connectivity sub-layer 220a-m includes a subset of the parameters of the input connectivity layer 210, and uses the subset of the parameters to process the respective proper subset of input channels 204a-n to generate the respective updated channel 212a-m.

In some implementations, each of the updated channel 212a-m has the same size. In some other implementations, different input channels 212a-m can have different sizes.

Thus, the input connectivity neural network layer 210 is configured to process N input channels 204a-n and generate M updated channels 212a-m. In some implementations, M=N. For example, each input connectivity sub-layer 220a-m can be configured to process exactly one input channel 204a-n to generate the corresponding updated channel 212a-m, where each input channel 204a-n is processed by exactly one input connectivity sub-layer 220a-m. In some other implementations, M>N, such that at least one input channel 204a-n is processed by multiple different input connectivity sub-layers 220a-m. In some other implementations, N>M, such that at least one input connectivity sub-layer 220a-m is configured to process multiple different input channels 204a-n.

In some implementations, each input connectivity sub-layer is configured to process the same number of input channels 204a-n. In some other implementations, different input connectivity sub-layers can be configured to process a different number of input channels 204a-n. For example, the first input connectivity sub-layer 220a is configured to process one input channel 204a, while the M^{th} input connectivity sub-layer 220m is configured to process two input channels 204a and 204n.

In some implementations, each input channel 204a-n is processed by the same number of input connectivity sub-layers 220a-m. In some other implementations, different input channels 204a-n are processed by a different number of input connectivity sub-layers 220a-m. For example, the first input channel 204a is processed by one input connectivity sub-layer 220a, while the N^{th} input channel 204n is processed by two input connectivity sub-layers 220a and 220m.

In some implementations, for each input connectivity sub-layer 220a-m, the size of the updated channel 212a-m generated by the sub-layer is the same as the size of the input channels 204a-n processed by the sub-layer. In some other implementations (e.g., as depicted in FIG. 2), the size of the updated channel 212a-m generated by the sub-layer has a different size than the input channels 204a-n processed by the sub-layer. For example, the updated channel 212a-m generated by the sub-layer can have the same dimensionality as the input channels 204a-n processed by the sub-layer while having more or fewer parameters. As another example, the updated channel 212a-m generated by the sub-layer can have a different dimensionality than the input channels 204a-n processed by the sub-layer.

Each input connectivity sub-layer 220a-n can use any appropriate architecture to generate the respective updated channel 212a-m.

For example, each input connectivity sub-layer 220a-m can be a fully-connected neural network layer. In this example, dividing the encoded network input 202 into the input channels 204a-n can still improve the efficiency of the connectivity neural network layer 210 compared to processed the full encoded network input 202 using a fully-connected neural network layer. As an illustrative example, if N=M, and if each input channel 204a-n has size L₁×W₁ and each updated channel has size L₂×W₂, then the number of parameters of the input connectivity neural network layer 210 is N·(L₁·W₁)·(L₂·W₂). If the input connectivity neural network layer 210 were a fully-connected neural network layer, then the number of parameters would be (L₁·W₁·N)·(L₂·W₂·N). Thus, dividing the encoded network input 202 into the input channels 204a-n improves the efficiency of the input connectivity neural network layer 210 by a factor of N.

As another example, each updated channel 212a-m can be a linear combination of the corresponding input channels 204a-n. That is, each input connectivity sub-layer 220a-m can generate its respective updated channel 212a-m by determining a weighted sum of its respective input channels 204a-n. As an illustrative example, if each sub-layer 220a-m processes k input channels 204a-n, then the input connectivity neural network layer 210 only has k·M learned parameters, a significant efficiency improvement over the case, described above, where the input connectivity neural network layer 210 is a fully-connected layer.

As another example, each input connectivity sub-layer can process the corresponding proper subset of input channels 204a-n using a convolutional kernel.

The brain emulation subnetwork 230 is configured to process the updated channels 212a-m and to generate P brain emulation channels 232a-p, P>1. As described above, the parameters of the brain emulation subnetwork 230 can be determined using synaptic connectivity between neurons in the brain of a biological organism. In some implementations, P=M. In some other implementations, P>M. In some other implementations, P<M.

In some implementations, each of the brain emulation channels 232a-p has the same size. In some other implementations, different brain emulation channels 232a-p can have different sizes.

In some implementations, the brain emulation subnetwork 230 does not process the updated channels 212a-m independently. Rather, the brain emulation subnetwork 230 can combine the updated channels 212a-m into a single brain emulation subnetwork input, and process the brain emulation subnetwork input to generate the brain emulation channels 232a-p.

In some implementations, the output of the brain emulation subnetwork 230 is not explicitly divided into the P brain emulation channels 232a-p. That is, the brain emulation subnetwork 230 can be configured to generate a single brain emulation output, and the neural network can then divide the brain emulation output into the brain emulation channels 232a-p. For example, the neural network can divide the brain emulation output in any way described above with reference to dividing the encoded network input 202.

In some implementations, the architecture of the brain emulation subnetwork 230 is represented using a weight matrix, where each element of the weight matrix is a respective parameter of the brain emulation subnetwork 230. Each element of the weight matrix can correspond to a pair of neurons in the brain of the biological organism, where the value of the element characterizes a strength of a neuronal connection between the pair of neurons. In other words, each row and column of the weight matrix can correspond to a respective neuron in the brain of the biological organism, and the value of each element characterizes a strength of a neuronal connection between (i) the neuron corresponding to the row of the element and (ii) the neuron corresponding to the column of the element. The process of generating the weight matrix is described in more detail below.

For example, the weight matrix of the brain emulation subnetwork 230 can have size M×P, such that the size of the brain emulation channels 232a-p is the same as the size of the updated channels 212a-m. In other words, each brain emulation channel 232a-p can be a linear combination of the updated channels 212a-m, where the linear combination corresponding to brain emulation channel 232i is defined by the i^{th} column of the weight matrix.

As another example, the brain emulation subnetwork 230 can be a fully-connected neural network layer. As an illustrative example, if the updated channels 212a-m have size L₂×W₂ and the brain emulation channels 232a-p have size L₃×W₃, then the weight matrix of the brain emulation subnetwork 230 has size (M·L₂·W₂)×(P·L₃·W₃).

In some implementations, the weight matrix is a square matrix where the same neurons in the brain of the biological organism are represented by both the rows and the columns of the weight matrix.

The output connectivity neural network layer 240 is configured to process the brain emulation channels 232a-p to generate Q output channels 252a-q, Q>1. The output connectivity neural network layer 240 can be configured similarly to the input connectivity layer 210. The output connectivity neural network layer 240 can have any of the configurations described above with reference to the input connectivity layer 210. In particular, the output connectivity neural network layer 240 can include Q output connectivity sub-layers 250a-q that are each configured to process a respective proper subset of the brain emulation channels 232a-p to generate a respective output channel 252a-q.

The neural network can process the output channels 252a-q using one or more subsequent trained neural network layers of the neural network to generate the network output for the neural network.

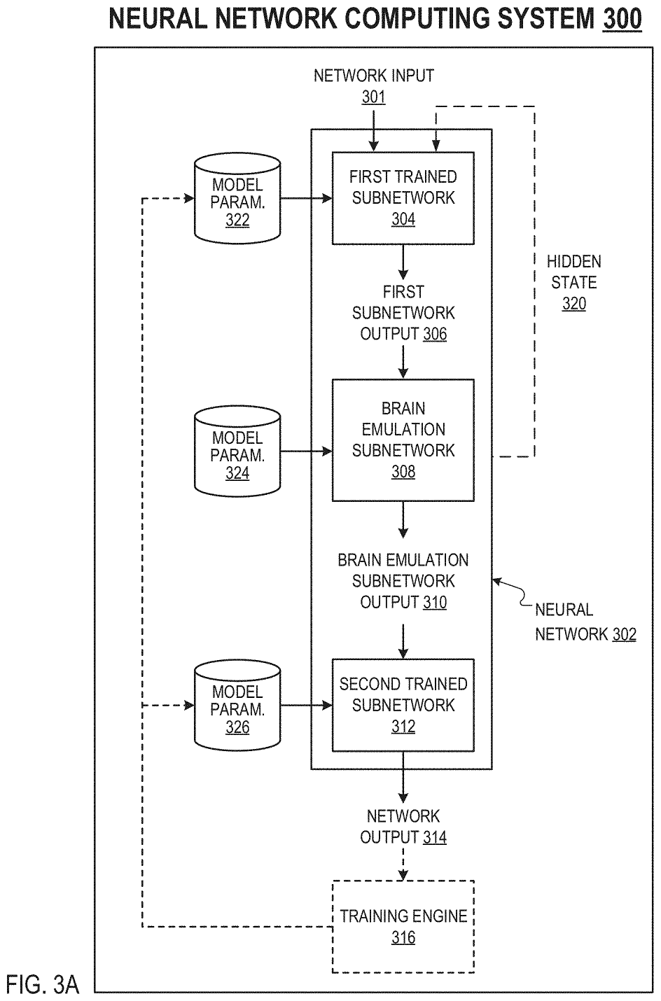

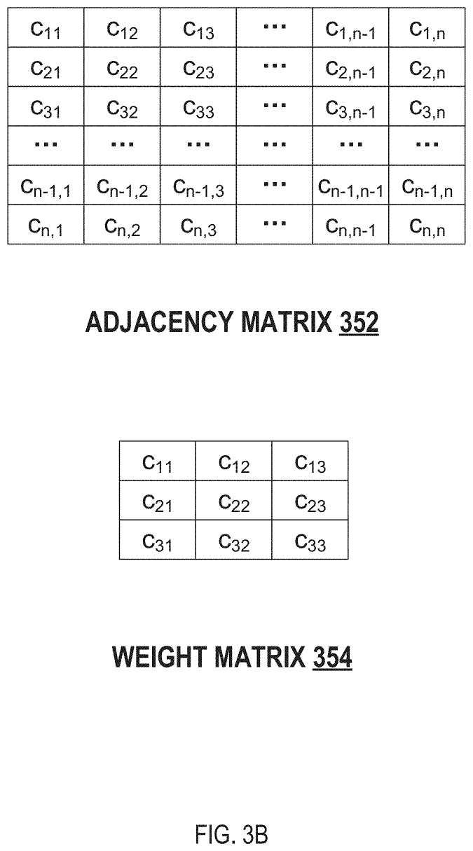

FIG. 3A shows an example neural network computing system 300. The neural network computing system 300 is an example of a system implemented as computer programs on one or more computers in one or more locations in which the systems, components, and techniques described below are implemented.

The neural network computing system 300 includes a neural network 302 that has (at least) three subnetworks: (i) a first trained subnetwork 304 (ii) a brain emulation subnetwork 308, and (iii) a second trained subnetwork 312. The neural network 302 is configured to process a network input 301 to generate a network output 314.

The first trained subnetwork 304 is configured to process the network input 301 in accordance with a set of model parameters 322 of the first trained subnetwork 304 to generate a first subnetwork output 306. The final neural network layer of the first trained subnetwork 204 can be a connectivity neural network layer, e.g., the input connectivity neural network layer 120 depicted in FIG. 1.

The brain emulation subnetwork 308 is configured to process the first subnetwork output 306 in accordance with a set of model parameters 324 of the brain emulation subnetwork 308 to generate a brain emulation subnetwork output 310.

The second trained subnetwork 312 is configured to process the brain emulation subnetwork output 310 in accordance with a set of model parameters 326 of the second trained subnetwork 312 to generate the network output 314. The first neural network layer of the second trained subnetwork 312 can be a connectivity neural network layer, e.g., the output connectivity neural network layer 140 depicted in FIG. 1.

The brain emulation subnetwork can include one or more brain emulation neural network layers whose respective architectures are represented by a weight matrix. For example, the brain emulation subnetwork 308 can be configured similarly to the brain emulation subnetwork 130 described above with reference to FIG. 1.

Although the neural network 302 depicted in FIG. 3 includes one trained subnetwork 304 before the brain emulation subnetwork 308 and one trained subnetwork 312 after the brain emulation subnetwork 308, in general the neural network 302 can include any number of trained subnetworks before and/or after the brain emulation subnetwork 308. In some implementations, the first trained subnetwork 304 and/or the second trained subnetwork 312 can include only one or a few neural network layers (e.g., a single fully-connected layer) that processes the respective subnetwork input to generate the respective subnetwork output.

In implementations where there are zero trained subnetworks before the brain emulation subnetwork 308, the brain emulation subnetwork 308 can receive the network input 301 directly as input. In implementations where there are zero trained subnetworks after the brain emulation subnetwork 308, the brain emulation subnetwork output 310 can be the network output 314.

Although the neural network 302 depicted in FIG. 3 includes a single brain emulation subnetwork 308, in general the neural network 302 can include multiple brain emulation subnetwork 308. In some implementations, each brain emulation subnetwork 308 has the same set of model parameters 324; in some other implementations, each brain emulation subnetwork 308 has a different set of model parameters 324. In some implementations, each brain emulation subnetwork 308 has the same network architecture; in some other implementations, each brain emulation subnetwork 308 has a different network architecture.

In some implementations, the neural network 302 is a recurrent neural network. In these implementations, the network input 301 includes a sequence of input elements. The first trained subnetwork 304 can process, at each of multiple time steps corresponding to respective input elements in the sequence, the input element to generate a respective first subnetwork output 306. At each time step, the brain emulation subnetwork 308 can process the first subnetwork output 306 to generate a respective brain emulation subnetwork output 310. At each time step, the second trained subnetwork 312 can process the brain emulation subnetwork output 310 to generate an output element corresponding to the input element.

At each time step, the neural network 302 can maintain a hidden state 320. That is, at each time step, the neural network 302 updates its hidden state 320; then, at the subsequent time step in the sequence of time steps, the neural network 302 receives as input (i) the input element of the network input 301 corresponding to the subsequent time step and (ii) the current hidden state 320.

In some implementations in which the neural network 302 is a recurrent neural network (e.g., in the example depicted in FIG. 3), the first trained subnetwork 304 receives both i) the input element of the sequence of the network input 301 and ii) the hidden state 320. For example, the recurrent neural network 302 can combine the input element and the hidden state 320 (e.g., through concatenation, addition, multiplication, or an exponential function) to generate a combined input, and then process the combined input using the first trained subnetwork 304.

In some implementations in which the neural network 302 is a recurrent neural network, the brain emulation subnetwork 308 receives as input the hidden state 320 and the first subnetwork output 306. For example, the neural network 302 can combine the first subnetwork output 306 and the hidden state 320 (e.g., through concatenation, addition, multiplication, or an exponential function) to generate a combined input, and then process the combined input using the brain emulation subnetwork 308.

In some implementations in which the neural network 302 is a recurrent neural network, the second trained subnetwork 312 receives as input the hidden state 320 and the brain emulation subnetwork output 310. For example, the neural network 302 can combine the brain emulation subnetwork output 310 and the hidden state 320 (e.g., through concatenation, addition, multiplication, or an exponential function) to generate a combined input, and then process the combined input using the second trained subnetwork 312.

In some implementations in which the neural network 302 is a recurrent neural network, the updated hidden state 320 generated at a time step is the same as the output element generated at the time step. In some other implementations, the hidden state 320 is an intermediate output of the neural network 302. An intermediate output refers to an output generated by a hidden artificial neuron or a hidden neural network layer of the neural network 302, i.e., an artificial neuron or neural network layer that is not included in the input layer or the output layer of the neural network 302. For example, the hidden state 320 can be the brain emulation subnetwork output 310. In some other implementations, the hidden state 320 is a combination of the output element and one or more intermediate outputs of the neural network 302. For example, the hidden state 320 can be computed using the output element and the brain emulation subnetwork output 310, e.g., by combining the two outputs and applying an activation function.

In some implementations in which the neural network 302 is a recurrent neural network, after each input element in the network input 301 has been processed by the recurrent neural network 302 to generate respective output elements, the recurrent neural network 302 can generate a network output 314 corresponding to the network input 301. In some such implementations, the network output 314 is the sequence of generated outputs elements. In some other implementations, the network output 314 is a subset of the generated output elements, e.g., the final output element corresponding to the final input element in the sequence of input elements of the network input 301. In some other implementations, the recurrent neural network 302 further processes the sequence of generated output elements to generate the network output 314. For example, the network output 314 can be the mean of the generated output elements.

In some implementations, the brain emulation subnetwork 308 itself has a recurrent neural network architecture. That is, the brain emulation subnetwork 308 can process the first subnetwork output 306 multiple times at respective sub-time steps (referred to as sub-time steps to differentiate from the time steps of the neural network 302 in implementations where the neural network 302 is a recurrent neural network).

For example, the architecture of the brain emulation subnetwork 308 can include a sequence of components (e.g., brain emulation neural network layers or groups of brain emulation neural network layers) such that the architecture includes a connection from each component in the sequence to the next component, and the first and last components of the sequence are identical. In one example, two brain emulation neural network layers that are each directly connected to one another (i.e., where the first layer provides its output the second layer, and the second layer provides its output to the first layer) would form a recurrent loop. A recurrent brain emulation subnetwork 308 can process the first subnetwork output 306 over multiple sub-time steps to generate a respective brain emulation subnetwork output 310 at each sub-time step. In particular, at each sub-time step, the brain emulation subnetwork 308 can process: (i) the first subnetwork output 306 (or a component of the first subnetwork output 306), and (ii) any outputs generated by the brain emulation subnetwork 308 at the preceding sub-time step, to generate the brain emulation subnetwork output 310 for the sub-time step. The neural network 302 can provide the brain emulation subnetwork output 310 generated by the brain emulation subnetwork 308 at the final sub-time step as the input to the second trained subnetwork 312. The number of sub-time steps over which the brain emulation subnetwork 308 processes a network input can be a predetermined hyper-parameter of the neural network computing system 300.

In some implementations, in addition to processing the brain emulation subnetwork output 310 generated by the output layer of the brain emulation subnetwork 308, the second trained subnetwork 312 can additionally process one or more intermediate outputs of the brain emulation subnetwork 308.

The neural network computing system 300 includes a training engine 316 that is configured to train the neural network 302.

In some implementations, the model parameters 324 for the brain emulation subnetwork 308 are untrained. Instead, the model parameters 324 of the brain emulation subnetwork 308 can be determined before the training of the trained subnetworks 304 and 312 based on the weight values of the edges in the synaptic connectivity graph. Optionally, the weight values of the edges in the synaptic connectivity graph can be transformed (e.g., by additive random noise) prior to being used for specifying model parameters 324 of the brain emulation subnetwork 308. This procedure enables the neural network 302 to take advantage of the information from the synaptic connectivity graph encoded into the brain emulation subnetwork 308 in performing prediction tasks.

Therefore, rather than training the entire neural network 302 from end-to-end, the training engine 316 can train only the model parameters 322 of the first trained subnetwork 304 and the model parameters 326 of the second trained subnetwork 312, while leaving the model parameters 324 of the brain emulation subnetwork 308 fixed during training.

The training engine 316 can train the neural network 302 on a set of training data over multiple training iterations. The training data can include a set of training examples, where each training example specifies: (i) a training network input, and (ii) a target network output that should be generated by the neural network 302 by processing the training network input.

At each training iteration, the training engine 316 can sample a batch of training examples from the training data, and process the training inputs specified by the training examples using the neural network 302 to generate corresponding network outputs 314. In particular, for each training input, the neural network 302 processes the training input using the current model parameter values 322 of the first trained subnetwork 304 to generate a first subnetwork output 306. The neural network 302 processes the first subnetwork output 306 in accordance with the static model parameter values 324 of the brain emulation subnetwork 308 to generate a brain emulation subnetwork output 310. The neural network 302 then processes the brain emulation subnetwork output 310 using the current model parameter values 326 of the second trained subnetwork 312 to generate the network output 314 corresponding to the training input.

The training engine 316 adjusts the model parameters values 322 of the first trained subnetwork 304 and the model parameter values 326 of the second trained subnetwork 312 to optimize an objective function that measures a similarity between: (i) the network outputs 314 generated by the neural network 302, and (ii) the target network outputs specified by the training examples. The objective function can be, e.g., a cross-entropy objective function, a squared-error objective function, or any other appropriate objective function.

To optimize the objective function, the training engine 316 can determine gradients of the objective function with respect to the model parameters 322 of the first trained subnetwork 304 and the model parameters 326 of the second trained subnetwork 312, e.g., using backpropagation techniques. The training engine 316 can then use the gradients to adjust the model parameter values 322 and 326, e.g., using any appropriate gradient descent optimization technique, e.g., an RMSprop or Adam gradient descent optimization technique.

The training engine 316 can use any of a variety of regularization techniques during training of the neural network 302. For example, the training engine 316 can use a dropout regularization technique, such that certain artificial neurons of the neural network 302 are “dropped out” (e.g., by having their output set to zero) with a non-zero probability p>0 each time the neural network 302 processes a network input. Using the dropout regularization technique can improve the performance of the trained neural network 302, e.g., by reducing the likelihood of over-fitting. As another example, the training engine 316 can regularize the training of the neural network 302 by including a “penalty” term in the objective function that measures the magnitude of the model parameter values 322 and 326 of the trained subnetworks 304 and 312. The penalty term can be, e.g., an L₁ or L₂ norm of the model parameter values 322 of the first trained subnetwork 304 and/or the model parameter values 326 of the second trained subnetwork 312.

In some other implementations, the model parameters 324 for the brain emulation subnetwork 308 are trained. That is, after initial values for the model parameters 324 of the brain emulation subnetwork 308 have been determined based on the weight values of the edges in the synaptic connectivity graph, the training engine 316 can update the weights of the model parameters, as described above with reference to the parameters 322 and 326 of the trained subnetworks, e.g., using backpropagation and stochastic gradient descent.

In some implementations, the training engine 316 trains multiple different versions of the neural network 302, e.g., using respective different hyper-parameter values for a set of hyper-parameters of the neural network 302. The training engine 316 can then select the version of the neural network 302 that has the highest performance (e.g., as measured by prediction accuracy) for deployment. As described above, the presence of the brain emulation subnetwork 308 can significantly reduce the amount of time required to train a version of the neural network. Therefore, inserting the brain emulation subnetwork 308 into the network architecture of the neural network 302 can allow the training engine 316 to train many more different versions of the neural network 302. Therefore, the training engine 316 can do a more exhaustive search of the space of hyper-parameter values in a reduces amount of time, providing the opportunity for the training engine 316 to train superior versions of the neural network 302 than if the neural network 302 did not include the brain emulation subnetwork 308.

The neural network 302 can be configured to perform any appropriate task. A few examples follow.

In one example, the neural network 302 can be configured to process network inputs 301 that represent sequences of audio data. For example, each input element in the network input 301 can be a raw audio sample or an input generated from a raw audio sample (e.g., a spectrogram), and the neural network 302 can process the sequence of input elements to generate network outputs 314 representing predicted text samples that correspond to the audio samples. That is, the neural network 302 can be a “speech-to-text” neural network. As another example, each input element can be a raw audio sample or an input generated from a raw audio sample, and the neural network 302 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, one or more weight matrices of the brain emulation subnetwork 308 can be generated from a subgraph of the synaptic connectivity graph corresponding to an audio region of the brain, i.e., a region of the brain that processes auditory information (e.g., the auditory cortex).

In another example, the neural network 302 can be configured to process network inputs 301 that represent sequences of text data. For example, each input element in the network input 301 can be a text sample (e.g., a character, phoneme, or word) or an embedding of a text sample, and the neural network 302 can process the sequence of input elements to generate network outputs 314 representing predicted audio samples that correspond to the text samples. That is, the neural network 302 can be a “text-to-speech” neural network. As another example, each input element can be an input text sample or an embedding of an input text sample, and the neural network 302 can generate a network output 314 representing a sequence of output text samples corresponding to the sequences of input text samples. As a particular example, the output text samples can represent the same text as the input text samples in a different language (i.e., the neural network 302 can be a machine translation neural network). As another particular example, the output text samples can represent an answer to a question posed by the input text samples (i.e., the neural network 302 can be a question-answering neural network). As another example, the input text samples can represent two texts (e.g., as separated by a delimiter token), and the neural network 302 can generate a network output representing a predicted similarity between the two texts. In some implementations, one or more weight matrices of the brain emulation subnetwork 308 can be generated from a subgraph of the synaptic connectivity graph corresponding to a speech region of the brain, i.e., a region of the brain that is linked to speech production (e.g., Broca's area).

In another example, the neural network 302 can be configured to process network inputs 301 representing one or more images, e.g., sequences of video frames. For example, each input element in the network input 301 can be a video frame or an embedding of a video frame, and the neural network 302 can process the sequence of input elements to generate a network output 314 representing a prediction about the video represented by the sequence of video frames. As a particular example, the neural network 302 can be configured to track a particular object in each of the frames of the video, i.e., to generate a network output 314 that includes a sequences of output elements, where each output elements represents a predicted location within a respective video frames of the particular object. In some implementations, the brain emulation subnetwork 308 can be generated from a subgraph of the synaptic connectivity graph corresponding to a visual region of the brain, i.e., a region of the brain that processes visual information (e.g., the visual cortex).

In another example, the neural network 302 can be configured to process a network input 301 representing a respective current state of an environment at each of one or more time points, and to generate a network output 314 representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

In this specification, an embedding is an ordered collection of numeric values that represents an input in a particular embedding space. For example, an embedding can be a vector of floating point or other numeric values that has a fixed dimensionality.

After training, the neural network 302 can be directly applied to perform prediction tasks. For example, the neural network 302 can be deployed onto a user device. In some implementations, the neural network 302 can be deployed directly into resource-constrained environments (e.g., mobile devices). Neural networks 302 that include brain emulation subnetworks 308 can generally perform at a high level, e.g., in terms of prediction accuracy, even with very few model parameters compared to other neural networks. For example, neural networks 302 as described in this specification that have, e.g., 100 or 1000 model parameters can achieve comparable performance to other neural networks that have millions of model parameters. Thus, the neural network 302 can be implemented efficiently and with low latency on user devices.

In some implementations, after the neural network 302 has been deployed onto a user device, some of the parameters of the neural network 302 can be further trained, i.e., “fine-tuned,” using new training example obtained by the user device. For example, some of the parameters can be fine-tuned using training example corresponding to the specific user of the user device, so that the neural network 302 can achieve a higher accuracy for inputs provided by the specific user. As a particular example, the model parameters 322 of the first trained subnetwork 304 and/or the model parameters 326 of the second trained subnetwork 312 can be fine-tuned on the user device using new training examples while the model parameters 324 of the brain emulation subnetwork 308 are held static, as described above.

FIG. 3B illustrates an example weight matrix 354 of a brain emulation neural network layer determined using synaptic connectivity

As described in more detail below with reference to FIG. 4B, a system (e.g., the graphing system 412 depicted in FIG. 4B), can generate a synaptic connectivity graph that represents the synaptic connectivity between neurons in the brain of the biological organism. The synaptic connectivity graph can be represented using an adjacency matrix 352, all of which or a portion of which can be used as the weight matrix 354 of the brain emulation neural network layer.

As illustrated in FIG. 3, the adjacency matrix 352 includes n² elements, where n is the number of neurons drawn from the brain of the biological organism. For example, the adjacency matrix 352 can include hundreds, thousands, tens of thousands, hundreds of thousands, millions, tens of millions, or hundreds of millions of elements.

Each element of the adjacency matrix 352 represents the synaptic connectivity between a respective pair of neurons in the set of n neurons. That is, each element c_{i,j} identifies the synaptic connection between neuron i and neuron j. As described in more detail below, in some implementations, each of the elements c_{i,j} are either zero (representing that there is no synaptic connection between the corresponding neurons) or one (representing that there is a synaptic connection between the corresponding neurons), while in some other implementations, each element c_{i,j} is a scalar value representing the strength of the synaptic connection between the corresponding neurons.

Each row and each column of the adjacency matrix 352 can represent a respective neuron in the brain of the biological organism.

In some implementations (e.g., in implementations in which the synaptic connectivity graph is undirected), the adjacency matrix 352 is symmetric (i.e., each element c_{i,j} is the same as element c_{i,j}), while in some other implementations (e.g., in implementations in which the synaptic connectivity graph is directed), the adjacency matrix 352 is not symmetric (i.e., there may exist elements c_{i,j} and c_{j,i} such that c_{i,j}≠c_{j,i}).

Although the above description refers to neurons in the brain of the biological organism, generally the elements of the adjacency matrix can correspond to pairs of any appropriate component of the brain of the biological organism. For example, each element can correspond to a pair of voxels in a voxel grid of the brain of the biological organism. As another example, each element can correspond to a pair of sub-neurons of the brain of the biological organism. As another example, each element can correspond to a pair of sets of multiple neurons of the brain of the biological organism.

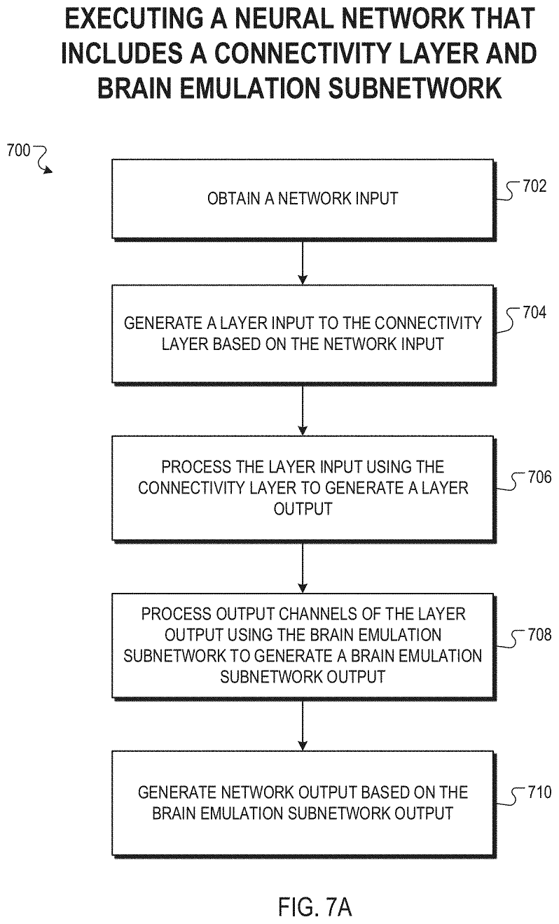

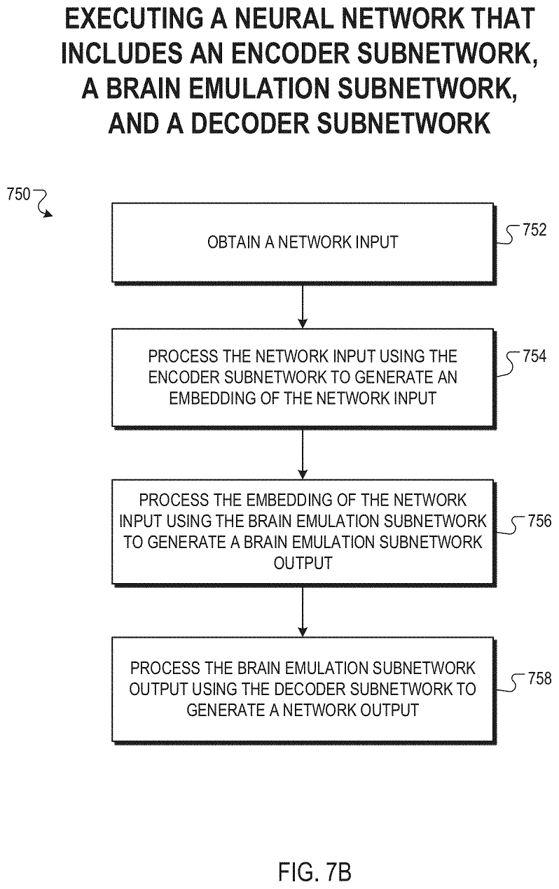

As described in more detail below with reference to FIG. 4, an architecture mapping system (e.g., the architecture mapping system 420 depicted in FIG. 4) can generate the weight matrix 354 from the adjacency matrix 352. Generally, the elements of the weight matrix 354 (i.e., the brain emulation parameters of the brain emulation neural network layer) are a subset of the elements of the adjacency matrix 352. For example, as depicted in FIG. 3, the weight matrix 354 includes the elements of the adjacency matrix 352 representing neuronal connections between the neurons represented by the first three rows and first three columns of the adjacency matrix 352. For example, the weight matrix 354 can represent only neurons of a particular type in the brain of the biological organism. Identifying neurons of a particular type is discussed in more detail below with reference to FIG. 7.

For convenience, the weight matrix 354 is illustrated as including only nine brain emulation parameters; generally, weight matrices of brain emulation neural network layers can have significantly more brain emulation parameters, e.g., hundreds, thousands, or millions of brain emulation parameters. Although the weight matrix 354 is depicted as square in FIG. 3 (i.e., the same number of columns and rows), generally the weight matrix 354 can have any appropriate dimensionality.

That is, generally the weight matrix 354 can be an M×N matrix, where each of the M rows corresponds to a neuron in a first set of neurons and each of the N columns corresponds to a neuron in a second set of neurons in the brain of the biological organism. The first set of neurons and the second set of neurons can be overlapping (i.e., one or more neurons in the brain of the biological organism is in both sets) or disjoint (i.e., there does not exist a neuron in the brain of the biological organism that is in both sets). As a particular example, the first set and the second set can be the same. That is, the weight matrix 354 can be an N×N matrix where the same neurons in the brain of the biological organism are represented by both the rows and the columns of the weight matrix. The process of generating the weight matrix is described in more detail below.

In some implementations, the weight matrix 354 represents the entire synaptic connectivity graph. That is, the weight matrix 354 can include a respective row and column for each node of the synaptic connectivity graph.

FIG. 4A illustrates an example of generating an artificial (i.e., computer implemented) brain emulation neural network 409 based on a synaptic resolution image 405 of the brain 403 of a biological organism 401, e.g., a fly. The synaptic resolution image 405 can be processed to generate a synaptic connectivity graph 407, e.g., where each node of the graph 407 corresponds to a neuron in the brain 403, and two nodes in the graph 407 are connected if the corresponding neurons in the brain 403 share a synaptic connection. The structure of the graph 407 can be used to specify the architecture of the brain emulation neural network 409. For example, each node of the graph 407 can mapped to an artificial neuron, a neural network layer, or a group of neural network layers in the brain emulation neural network 409. Further, each edge of the graph 407 can be mapped to a connection between artificial neurons, layers, or groups of layers in the brain emulation neural network 409. The brain 403 of the biological organism 401 can be adapted by evolutionary pressures to be effective at solving certain tasks, e.g., classifying objects or generating robust object representations, and the brain emulation neural network 409 can share this capacity to effectively solve tasks.

FIG. 4B shows an example data flow 400 for generating a synaptic connectivity graph 402 and a brain emulation neural network 404 based on the brain 406 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 408 can be used to generate a synaptic resolution image 410 of the brain 406. An image of the brain 406 may be referred to as having synaptic resolution if it has a spatial resolution that is sufficiently high to enable the identification of at least some synapses in the brain 406. Put another way, an image of the brain 406 may be referred to as having synaptic resolution if it depicts the brain 406 at a magnification level that is sufficiently high to enable the identification of at least some synapses in the brain 406. The image 410 can be a volumetric image, i.e., that characterizes a three-dimensional representation of the brain 406. The image 410 can be represented in any appropriate format, e.g., as a three-dimensional array of numerical values.

The imaging system 408 can be any appropriate system capable of generating synaptic resolution images, e.g., an electron microscopy system. The imaging system 408 can process “thin sections” from the brain 406 (i.e., thin slices of the brain attached to slides) to generate output images that each have a field of view corresponding to a proper subset of a thin section. The imaging system 408 can generate a complete image of each thin section by stitching together the images corresponding to different fields of view of the thin section using any appropriate image stitching technique. The imaging system 408 can generate the volumetric image 410 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 412 is configured to process the synaptic resolution image 410 to generate the synaptic connectivity graph 402. The synaptic connectivity graph 402 specifies a set of nodes and a set of edges, such that each edge connects two nodes. To generate the graph 402, the graphing system 412 identifies each neuron in the image 410 as a respective node in the graph, and identifies each synaptic connection between a pair of neurons in the image 410 as an edge between the corresponding pair of nodes in the graph.

The graphing system 412 can identify the neurons and the synapses depicted in the image 410 using any of a variety of techniques. For example, the graphing system 412 can process the image 410 to identify the positions of the neurons depicted in the image 410, and determine whether a synapse connects two neurons based on the proximity of the neurons (as will be described in more detail below). In this example, the graphing system 412 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 412 can identify contiguous clusters of voxels in the neuron probability map as being neurons.

Optionally, prior to identifying the neurons from the neuron probability map, the graphing system 412 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 412 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 410 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 412 can identify the synapses connecting the neurons in the image 410 based on the proximity of the neurons. For example, the graphing system 412 can determine that a first neuron is connected by a synapse to a second neuron based on the area of overlap between: (i) a tolerance region in the image around the first neuron, and (ii) a tolerance region in the image around the second neuron. That is, the graphing system 412 can determine whether the first neuron and the second neuron are connected based on the number of spatial locations (e.g., voxels) that are included in both: (i) the tolerance region around the first neuron, and (ii) the tolerance region around the second neuron. For example, the graphing system 412 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 412 can further identify a weight value associated with each edge in the graph 402. For example, the graphing system 412 can identify a weight for an edge connecting two nodes in the graph 402 based on the area of overlap between the tolerance regions around the respective neurons corresponding to the nodes in the image 410. The area of overlap can be measured, e.g., as the number of voxels in the image 410 that are contained in the overlap of the respective tolerance regions around the neurons. The weight for an edge connecting two nodes in the graph 402 may be understood as characterizing the (approximate) strength of the connection between the corresponding neurons in the brain (e.g., the amount of information flow through the synapse connecting the two neurons).

In addition to identifying synapses in the image 410, the graphing system 412 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 412 determines the directions of the synapses in the image 410, the graphing system 412 can associate each edge in the graph 402 with the direction of the corresponding synapse. That is, the graph 402 can be a directed graph. In some other implementations, the graph 402 can be an undirected graph, i.e., where the edges in the graph are not associated with a direction.

The graph 402 can be represented in any of a variety of ways. For example, the graph 402 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 412 determines a weight value for each edge in the graph 402, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

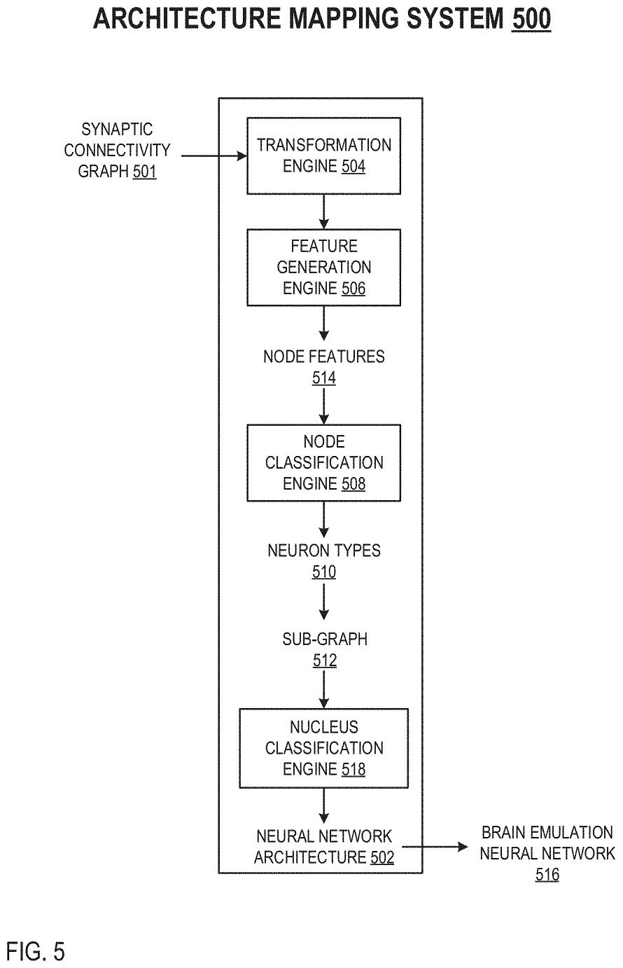

An architecture mapping system 420 can process the synaptic connectivity graph 402 to determine the architecture of the brain emulation neural network 404 (or a brain emulation subnetwork of a neural network). For example, the architecture mapping system 420 can map each node in the graph 402 to: (i) an artificial neuron, (ii) a neural network layer, or (iii) a group of neural network layers, in the architecture of the brain emulation neural network 404. The architecture mapping system 420 can further map each edge of the graph 402 to a connection in the brain emulation neural network 404, e.g., such that a first artificial neuron that is connected to a second artificial neuron is configured to provide its output to the second artificial neuron. In some implementations, the architecture mapping system 420 can apply one or more transformation operations to the graph 402 before mapping the nodes and edges of the graph 402 to corresponding components in the architecture of the brain emulation neural network 404, as will be described in more detail below. An example architecture mapping system is described in more detail below with reference to FIG. 5.

The brain emulation neural network 404 can be provided to a training system 414 that trains the brain emulation neural network using machine learning techniques, i.e., generates an update to the respective values of one or more parameters of the brain emulation neural network.

In some implementations, the training system 414 is a supervised training system that is configured to train the brain emulation neural network 404 using a set of training data. The training data can include multiple training examples, where each training example specifies: (i) a training input, and (ii) a corresponding target output that should be generated by the brain emulation neural network 404 by processing the training input. In one example, the direct training system 414 can train the brain emulation neural network 404 over multiple training iterations using a gradient descent optimization technique, e.g., stochastic gradient descent. In this example, at each training iteration, the direct training system 414 can sample a “batch” (set) of one or more training examples from the training data, and process the training inputs specified by the training examples to generate corresponding network outputs. The direct training system 414 can evaluate an objective function that measures a similarity between: (i) the target outputs specified by the training examples, and (ii) the network outputs generated by the brain emulation neural network, e.g., a cross-entropy or squared-error objective function. The direct training system 414 can determine gradients of the objective function, e.g., using backpropagation techniques, and update the parameter values of the brain emulation neural network 404 using the gradients, e.g., using any appropriate gradient descent optimization algorithm, e.g., RMSprop or Adam.

In some other implementations, the training system 414 is an adversarial training system that is configured to train the brain emulation neural network 404 in an adversarial fashion. For example, the training system 414 can include a discriminator neural network that is configured to process network outputs generated by the brain emulation neural network 404 to generate a prediction of whether the network outputs are “real” outputs (i.e., outputs that were not generated by the brain emulation neural network, e.g., outputs that represent data that was captured from the real world) or “synthetic” outputs (i.e., outputs generated by the brain emulation neural network 404). The training system can then determine an update to the parameters of the brain emulation neural network in order to increase an error in the prediction of the discriminator neural network; that is, the goal of the brain emulation neural network is to generate synthetic outputs that are realistic enough that the discriminator neural network predicts them to be real outputs. In some implementations, concurrently with training the brain emulation neural network 404, the training system 414 generates updates to the parameters of the discriminator neural network.

In some other implementations, the training system 414 is a distillation training system that is configured to use the brain emulation neural network 404 to facilitate training of a “student” neural network having a less complex architecture than the brain emulation neural network 404. The complexity of a neural network architecture can be measured, e.g., by the number of parameters required to specify the operations performed by the neural network. The training system 414 can train the student neural network to match the outputs generated by the brain emulation neural network. After training, the student neural network can inherit the capacity of the brain emulation neural network 404 to effectively solve certain tasks, while consuming fewer computational resources (e.g., memory and computing power) than the brain emulation neural network 404. Typically, the training system 414 does not update the parameters of the brain emulation neural network 404 while training the student neural network. That is, in these implementations, the training system 414 is configured to train the student neural network instead of the brain emulation neural network 404.

As a particular example, the training system 414 can be a distillation training system that trains the student neural network in an adversarial manner. For example, the training system 414 can include a discriminator neural network that is configured to process network outputs that were generated either by the brain emulation neural network 404 or the student neural network, and to generate a prediction of whether the network outputs where generated by the brain emulation neural network 404 or the student neural network. The training system can then determine an update to the parameters of the student neural network in order to increase an error in the prediction of the discriminator neural network; that is, the goal of the student neural network is to generate network outputs that resemble network outputs generated by the brain emulation neural network 402 so that the discriminator neural network predicts that they were generated by the brain emulation neural network 404.

In some implementations, the brain emulation neural network 404 is a subnetwork of a neural network that includes one or more other neural network layers, e.g., one or more other subnetworks.

For example, the brain emulation neural network 404 can be a subnetwork of a “reservoir computing” neural network. The reservoir computing neural network can include i) the brain emulation neural network, which includes untrained parameters, and ii) one or more other subnetworks that include trained parameters. For example, the reservoir computing neural network can be configured to process a network input using the brain emulation neural network 404 to generate an alternative representation of the network input, and process the alternative representation of the network input using a “prediction” subnetwork to generate a network output.

During training of the reservoir computing neural network, the parameter values of the one or more other subnetworks (e.g., the prediction subnetwork) are trained, but the parameter values of the brain emulation neural network 404 are static, i.e., are not trained. Instead of being trained, the parameter values of the brain emulation neural network 404 can be determined from the weight values of the edges of the synaptic connectivity graph, as will be described in more detail below. The reservoir computing neural network facilitates application of the brain emulation neural network to machine learning tasks by obviating the need to train the parameter values of the brain emulation neural network 404.

After the training system 414 has completed training the brain emulation neural network 404 (or a neural network that includes the brain emulation neural network as a subnetwork, or a student neural network trained using the brain emulation neural network), the brain emulation neural network 404 can be deployed by a deployment system 422. That is, the operations of the brain emulation neural network 404 can be implemented on a device or a system of devices for performing inference, i.e., receiving network inputs and processing the network inputs to generate network outputs. In some implementations, the brain emulation neural network 404 can be deployed onto a cloud system, i.e., a distributed computing system having multiple computing nodes, e.g., hundreds or thousands of computing nodes, in one or more locations. In some other implementations, the brain emulation neural network 404 can be deployed onto a user device.

For example, the brain emulation neural network 404 (or a neural network that includes the brain emulation neural network as a subnetwork, or a student neural network that has been trained using the brain emulation neural network) can be deployed as a recurrent neural network that is configured to process a sequence of network inputs, as described above.

FIG. 5 shows an example architecture mapping system 500. The architecture mapping system 500 is an example of a system implemented as computer programs on one or more computers in one or more locations in which the systems, components, and techniques described below are implemented.

The architecture mapping system 500 is configured to process a synaptic connectivity graph 501 (e.g., the synaptic connectivity graph 402 depicted in FIG. 4) to determine a corresponding neural network architecture 502 of a brain emulation neural network 516 (e.g., the brain emulation neural network 404 depicted in FIG. 4). The architecture mapping system 500 can determine the architecture 502 using one or more of: a transformation engine 504, a feature generation engine 506, a node classification engine 508, and a nucleus classification engine 518, which will each be described in more detail next.

The transformation engine 504 can be configured to apply one or more transformation operations to the synaptic connectivity graph 501 that alter the connectivity of the graph 501, i.e., by adding or removing edges from the graph. A few examples of transformation operations follow.

In one example, to apply a transformation operation to the graph 501, the transformation engine 504 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 504 can modify the connectivity between the two nodes in the node pair with a predefined probability (e.g., 0.1%). In one example, the transformation engine 504 can connect the nodes by an edge (i.e., if they are not already connected by an edge) with the predefined probability. In another example, the transformation engine 504 can reverse the direction of any edge connecting the two nodes with the predefined probability. In another example, the transformation engine 504 can invert the connectivity between the two nodes with the predefined probability, i.e., by adding an edge between the nodes if they are not already connected, and by removing the edge between the nodes if they are already connected.

In another example, the transformation engine 504 can apply a convolutional filter to a representation of the graph 501 as a two-dimensional array of numerical values. As described above, the graph 501 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 504 can quantize the values in the array representing the graph, e.g., by rounding each value in the array to 0 or 1, to cause the array to unambiguously specify the connectivity of the graph. Applying a convolutional filter to the representation of the graph 501 can have the effect of regularizing the graph, e.g., by smoothing the values in the array representing the graph to reduce the likelihood of a component in the array having a different value than many of its neighbors.

In some cases, the graph 501 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The architecture mapping system 500 can use the feature generation engine 506 and the node classification engine 508 to determine predicted “types” 510 of the neurons corresponding to the nodes in the graph 501. The type of a neuron can characterize any appropriate aspect of the neuron. In one example, the type of a neuron can characterize the function performed by the neuron in the brain, e.g., a visual function by processing visual data, an olfactory function by processing odor data, or a memory function by retaining information. After identifying the types of the neurons corresponding to the nodes in the graph 501, the architecture mapping system 500 can identify a sub-graph 512 of the overall graph 501 based on the neuron types, and determine the neural network architecture 502 based on the sub-graph 512. The feature generation engine 506 and the node classification engine 508 are described in more detail next.

The feature generation engine 506 can be configured to process the graph 501 (potentially after it has been modified by the transformation engine 504) to generate one or more respective node features 514 corresponding to each node of the graph 501. The node features corresponding to a node can characterize the topology (i.e., connectivity) of the graph relative to the node. In one example, the feature generation engine 506 can generate a node degree feature for each node in the graph 501, where the node degree feature for a given node specifies the number of other nodes that are connected to the given node by an edge. In another example, the feature generation engine 506 can generate a path length feature for each node in the graph 501, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 506 can generate a neighborhood size feature for each node in the graph 501, where the neighborhood size feature for a given node specifies the number of other nodes that are connected to the node by a path of length at most N. In this example, N can be a positive integer value. In another example, the feature generation engine 506 can generate an information flow feature for each node in the graph 501. The information flow feature for a given node can specify the fraction of the edges connected to the given node that are outgoing edges, i.e., the fraction of edges connected to the given node that point from the given node to a different node.

In some implementations, the feature generation engine 506 can generate one or more node features that do not directly characterize the topology of the graph relative to the nodes. In one example, the feature generation engine 506 can generate a spatial position feature for each node in the graph 501, where the spatial position feature for a given node specifies the spatial position in the brain of the neuron corresponding to the node, e.g., in a Cartesian coordinate system of the synaptic resolution image of the brain. In another example, the feature generation engine 506 can generate a feature for each node in the graph 501 indicating whether the corresponding neuron is excitatory or inhibitory. In another example, the feature generation engine 506 can generate a feature for each node in the graph 501 that identifies the neuropil region associated with the neuron corresponding to the node.

In some cases, the feature generation engine 506 can use weights associated with the edges in the graph in determining the node features 514. As described above, a weight value for an edge connecting two nodes can be determined, e.g., based on the area of any overlap between tolerance regions around the neurons corresponding to the nodes. In one example, the feature generation engine 506 can determine the node degree feature for a given node as a sum of the weights corresponding to the edges that connect the given node to other nodes in the graph. In another example, the feature generation engine 506 can determine the path length feature for a given node as a sum of the edge weights along the longest path in the graph starting from the node.

The node classification engine 508 can be configured to process the node features 514 to identify a predicted neuron type 510 corresponding to certain nodes of the graph 501. In one example, the node classification engine 508 can process the node features 514 to identify a proper subset of the nodes in the graph 501 with the highest values of the path length feature. For example, the node classification engine 508 can identify the nodes with a path length feature value greater than the 90th percentile (or any other appropriate percentile) of the path length feature values of all the nodes in the graph. The node classification engine 508 can then associate the identified nodes having the highest values of the path length feature with the predicted neuron type of “primary sensory neuron.” In another example, the node classification engine 508 can process the node features 514 to identify a proper subset of the nodes in the graph 501 with the highest values of the information flow feature, i.e., indicating that many of the edges connected to the node are outgoing edges. The node classification engine 508 can then associate the identified nodes having the highest values of the information flow feature with the predicted neuron type of “sensory neuron.” In another example, the node classification engine 508 can process the node features 514 to identify a proper subset of the nodes in the graph 501 with the lowest values of the information flow feature, i.e., indicating that many of the edges connected to the node are incoming edges (i.e., edges that point towards the node). The node classification engine 508 can then associate the identified nodes having the lowest values of the information flow feature with the predicted neuron type of “associative neuron.”

The architecture mapping system 500 can identify a sub-graph 512 of the overall graph 501 based on the predicted neuron types 510 corresponding to the nodes of the graph 501. A “sub-graph” may refer to a graph specified by: (i) a proper subset of the nodes of the graph 501, and (ii) a proper subset of the edges of the graph 501. FIG. 6 provides an illustration of an example sub-graph of an overall graph. In one example, the architecture mapping system 500 can select: (i) each node in the graph 501 corresponding to particular neuron type, and (ii) each edge in the graph 501 that connects nodes in the graph corresponding to the particular neuron type, for inclusion in the sub-graph 512. The neuron type selected for inclusion in the sub-graph can be, e.g., visual neurons, olfactory neurons, memory neurons, or any other appropriate type of neuron. In some cases, the architecture mapping system 500 can select multiple neuron types for inclusion in the sub-graph 512, e.g., both visual neurons and olfactory neurons.

The type of neuron selected for inclusion in the sub-graph 512 can be determined based on the task which the brain emulation neural network 516 will be configured to perform. In one example, the brain emulation neural network 516 can be configured to perform an image processing task, and neurons that are predicted to perform visual functions (i.e., by processing visual data) can be selected for inclusion in the sub-graph 512. In another example, the brain emulation neural network 516 can be configured to perform an odor processing task, and neurons that are predicted to perform odor processing functions (i.e., by processing odor data) can be selected for inclusion in the sub-graph 512. In another example, the brain emulation neural network 516 can be configured to perform an audio processing task, and neurons that are predicted to perform audio processing (i.e., by processing audio data) can be selected for inclusion in the sub-graph 512.

If the edges of the graph 501 are associated with weight values (as described above), then each edge of the sub-graph 512 can be associated with the weight value of the corresponding edge in the graph 501. The sub-graph 512 can be represented, e.g., as a two-dimensional array of numerical values, as described with reference to the graph 501.

Determining the architecture 502 of the brain emulation neural network 516 based on the sub-graph 512 rather than the overall graph 501 can result in the architecture 502 having a reduced complexity, e.g., because the sub-graph 512 has fewer nodes, fewer edges, or both than the graph 501. Reducing the complexity of the architecture 502 can reduce consumption of computational resources (e.g., memory and computing power) by the brain emulation neural network 516, e.g., enabling the brain emulation neural network 516 to be deployed in resource-constrained environments, e.g., mobile devices. Reducing the complexity of the architecture 502 can also facilitate training of the brain emulation neural network 516, e.g., by reducing the amount of training data required to train the brain emulation neural network 516 to achieve an threshold level of performance (e.g., prediction accuracy).

In some cases, the architecture mapping system 500 can further reduce the complexity of the architecture 502 using a nucleus classification engine 518. In particular, the architecture mapping system 500 can process the sub-graph 512 using the nucleus classification engine 518 prior to determining the architecture 502. The nucleus classification engine 518 can be configured to process a representation of the sub-graph 512 as a two-dimensional array of numerical values (as described above) to identify one or more “clusters” in the array.

A cluster in the array representing the sub-graph 512 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 518 can identify contiguous regions of the array such that at least a threshold fraction of the components in the region have the value 1. The nucleus classification engine 518 can identify clusters in the array representing the sub-graph 512 by processing the array using a blob detection algorithm, e.g., by convolving the array with a Gaussian kernel and then applying the Laplacian operator to the array. After applying the Laplacian operator, the nucleus classification engine 518 can identify each component of the array having a value that satisfies a predefined threshold as being included in a cluster.

Each of the clusters identified in the array representing the sub-graph 512 can correspond to edges connecting a “nucleus” (i.e., group) of related neurons in brain, e.g., a thalamic nucleus, a vestibular nucleus, a dentate nucleus, or a fastigial nucleus. After the nucleus classification engine 518 identifies the clusters in the array representing the sub-graph 512, the architecture mapping system 500 can select one or more of the clusters for inclusion in the sub-graph 512. The architecture mapping system 500 can select the clusters for inclusion in the sub-graph 512 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 500 can select a predefined number of largest clusters (i.e., that include the greatest number of edges) for inclusion in the sub-graph 512.

The architecture mapping system 500 can reduce the sub-graph 512 by removing any edge in the sub-graph 512 that is not included in one of the selected clusters, and then map the reduced sub-graph 512 to a corresponding neural network architecture, as will be described in more detail below. Reducing the sub-graph 512 by restricting it to include only edges that are included in selected clusters can further reduce the complexity of the architecture 502, thereby reducing computational resource consumption by the brain emulation neural network 516 and facilitating training of the brain emulation neural network 516.

The architecture mapping system 500 can determine the architecture 502 of the brain emulation neural network 516 from the sub-graph 512 in any of a variety of ways. For example, the architecture mapping system 500 can map each node in the sub-graph 512 to a corresponding: (i) artificial neuron, (ii) artificial neural network layer, or (iii) group of artificial neural network layers in the architecture 502, as will be described in more detail next.

In one example, the neural network architecture 502 can include: (i) a respective artificial neuron corresponding to each node in the sub-graph 512, and (ii) a respective connection corresponding to each edge in the sub-graph 512. In this example, the sub-graph 512 can be a directed graph, and an edge that points from a first node to a second node in the sub-graph 512 can specify a connection pointing from a corresponding first artificial neuron to a corresponding second artificial neuron in the architecture 502. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 502 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {αᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 512 can be an undirected graph, and the architecture mapping system 500 can map an edge that connects a first node to a second node in the sub-graph 512 to two connections between a corresponding first artificial neuron and a corresponding second artificial neuron in the architecture. In particular, the architecture mapping system 500 can map the edge to: (i) a first connection pointing from the first artificial neuron to the second artificial neuron, and (ii) a second connection pointing from the second artificial neuron to the first artificial neuron.

In another example, the sub-graph 512 can be an undirected graph, and the architecture mapping system can map an edge that connects a first node to a second node in the sub-graph 512 to one connection between a corresponding first artificial neuron and a corresponding second artificial neuron in the architecture. The architecture mapping system 500 can determine the direction of the connection between the first artificial neuron and the second artificial neuron, e.g., by randomly sampling the direction in accordance with a probability distribution over the set of two possible directions.

In some cases, the edges in the sub-graph 512 is not be associated with weight values, and the weight values corresponding to the connections in the architecture 502 can be determined randomly. For example, the weight value corresponding to each connection in the architecture 502 can be randomly sampled from a predetermined probability distribution, e.g., a standard Normal (N(0,1)) probability distribution.

In another example, the neural network architecture 502 can include: (i) a respective artificial neural network layer corresponding to each node in the sub-graph 512, and (ii) a respective connection corresponding to each edge in the sub-graph 512. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 502 can include a respective convolutional neural network layer corresponding to each node in the sub-graph 512, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 500 can determine that the neural network architecture includes: (i) a respective group of artificial neural network layers corresponding to each node in the sub-graph 512, and (ii) a respective connection corresponding to each edge in the sub-graph 512. The layers in a group of artificial neural network layers corresponding to a node in the sub-graph 512 can be connected, e.g., as a linear sequence of layers, or in any other appropriate manner.

Various operations performed by the described architecture mapping system 500 are optional or can be implemented in a different order. For example, the architecture mapping system 500 can refrain from applying transformation operations to the graph 501 using the transformation engine 504, and refrain from extracting a sub-graph 512 from the graph 501 using the feature generation engine 506, the node classification engine 508, and the nucleus classification engine 518. In this example, the architecture mapping system 500 can directly map the graph 501 to the neural network architecture 502, e.g., by mapping each node in the graph to an artificial neuron and mapping each edge in the graph to a connection in the architecture, as described above.

FIG. 6 illustrates an example graph 600 and an example sub-graph 602. Each node in the graph 600 is represented by a circle (e.g., 604 and 606), and each edge in the graph 600 is represented by a line (e.g., 608 and 610). In this illustration, the graph 600 can be considered a simplified representation of a synaptic connectivity graph (an actual synaptic connectivity graph can have far more nodes and edges than are depicted in FIG. 6). A sub-graph 602 can be identified in the graph 600, where the sub-graph 602 includes a proper subset of the nodes and edges of the graph 600. In this example, the nodes included in the sub-graph 602 are hatched (e.g., 606) and the edges included in sub-graph 602 are dashed (e.g., 610). The nodes included in the sub-graph 602 can correspond to neurons of a particular type, e.g., neurons having a particular function, e.g., olfactory neurons, visual neurons, or memory neurons. The architecture of the brain emulation neural network can be specified by the structure of the entire graph 600, or by the structure of a sub-graph 602, as described above.

FIG. 7A is a flow diagram of an example process 700 for executing a neural network that includes a connectivity layer and a brain emulation subnetwork. For convenience, the process 700 will be described as being performed by a system of one or more computers located in one or more locations. For example, a neural network computing system, e.g., the neural network computing system 100 depicted in FIG. 1, appropriately programmed in accordance with this specification, can perform the process 700.

The system obtains a network input (step 702).

The system generates a layer input to the connectivity layer based on the network input (step 704). The layer input to the connectivity layer includes multiple input values arranged in multiple input channels.

The system processes the layer input using the connectivity layer to generate a layer output (step 706). The layer output includes multiple output values arranged in multiple output channels. The connectivity layer generates each output channel by processing a respective proper subset of the multiple input channels.

The system processes the output channels of the layer output using the brain emulation subnetwork to generate a brain emulation subnetwork output (step 708). The brain emulation subnetwork includes multiple brain emulation parameters each corresponding to a respective synaptic connection between a respective pair of biological neurons in the brain of a biological organism. Values for the brain emulation parameters are specified by synaptic connectivity between the biological neurons in the brain of the biological organism.

The system generates a network output based on the brain emulation subnetwork output (step 710).

FIG. 7B is a flow diagram of an example process 750 for executing a neural network that includes an encoder subnetwork, a brain emulation subnetwork, and a decoder subnetwork. For convenience, the process 750 will be described as being performed by a system of one or more computers located in one or more locations. For example, a neural network computing system, e.g., the neural network computing system 100 depicted in FIG. 1, appropriately programmed in accordance with this specification, can perform the process 750.

The system obtains a network input (step 752).

The system processes the network input using the encoder subnetwork to generate an embedding of the network input (step 754).

The system processes the embedding of the network input using the brain emulation subnetwork to generate a brain emulation subnetwork output (step 756). The brain emulation subnetwork includes multiple brain emulation parameters each corresponding to a respective synaptic connection between a respective pair of biological neurons in the brain of a biological organism. Values for the brain emulation parameters are specified by synaptic connectivity between the biological neurons in the brain of the biological organism.

The system processes the brain emulation subnetwork output using the decoder subnetwork to generate a network output for the neural network (step 758).

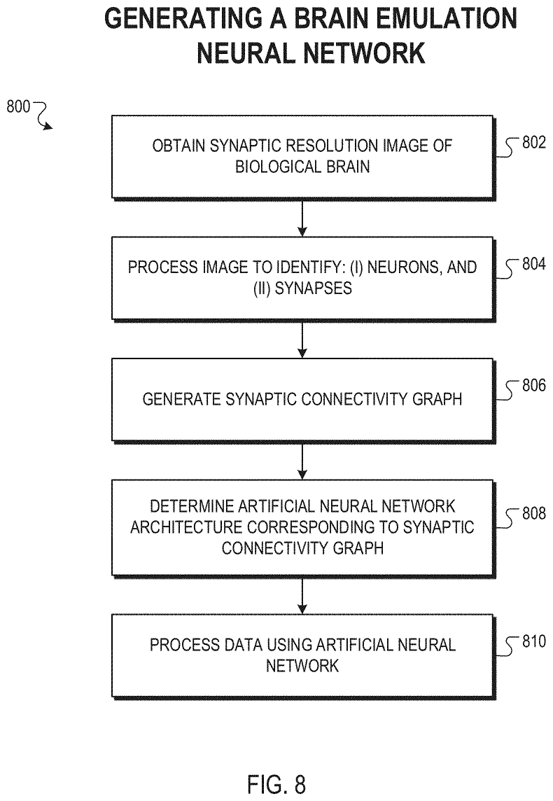

FIG. 8 is a flow diagram of an example process 800 for generating a brain emulation neural network. For convenience, the process 800 will be described as being performed by a system of one or more computers located in one or more locations.

The system obtains a synaptic resolution image of at least a portion of a brain of a biological organism (802).

The system processes the image to identify: (i) neurons in the brain, and (ii) synaptic connections between the neurons in the brain (804). The system generates data defining a graph representing synaptic connectivity between the neurons in the brain (806). The graph includes a set of nodes and a set of edges, where each edge connects a pair of nodes. The system identifies each neuron in the brain as a respective node in the graph, and each synaptic connection between a pair of neurons in the brain as an edge between a corresponding pair of nodes in the graph.

The system determines an artificial neural network architecture corresponding to the graph representing the synaptic connectivity between the neurons in the brain (808).

The system processes a network input using an artificial neural network having the artificial neural network architecture to generate a network output (810).

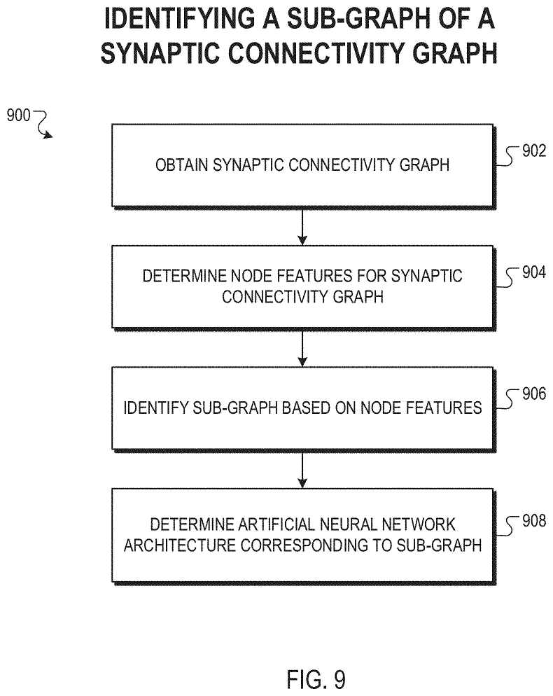

FIG. 9 is a flow diagram of an example process 900 for determining an artificial neural network architecture corresponding to a sub-graph of a synaptic connectivity graph. For convenience, the process 900 will be described as being performed by a system of one or more computers located in one or more locations. For example, an architecture mapping system, e.g., the architecture mapping system 500 of FIG. 5, appropriately programmed in accordance with this specification, can perform the process 900.

The system obtains data defining a graph representing synaptic connectivity between neurons in a brain of a biological organism (902). The graph includes a set of nodes and edges, where each edge connects a pair of nodes. Each node corresponds to a respective neuron in the brain of the biological organism, and each edge connecting a pair of nodes in the graph corresponds to a synaptic connection between a pair of neurons in the brain of the biological organism.

The system determines, for each node in the graph, a respective set of one or more node features characterizing a structure of the graph relative to the node (904).

The system identifies a sub-graph of the graph (906). In particular, the system selects a proper subset of the nodes in the graph for inclusion in the sub-graph based on the node features of the nodes in the graph.

The system determines an artificial neural network architecture corresponding to the sub-graph of the graph (908).

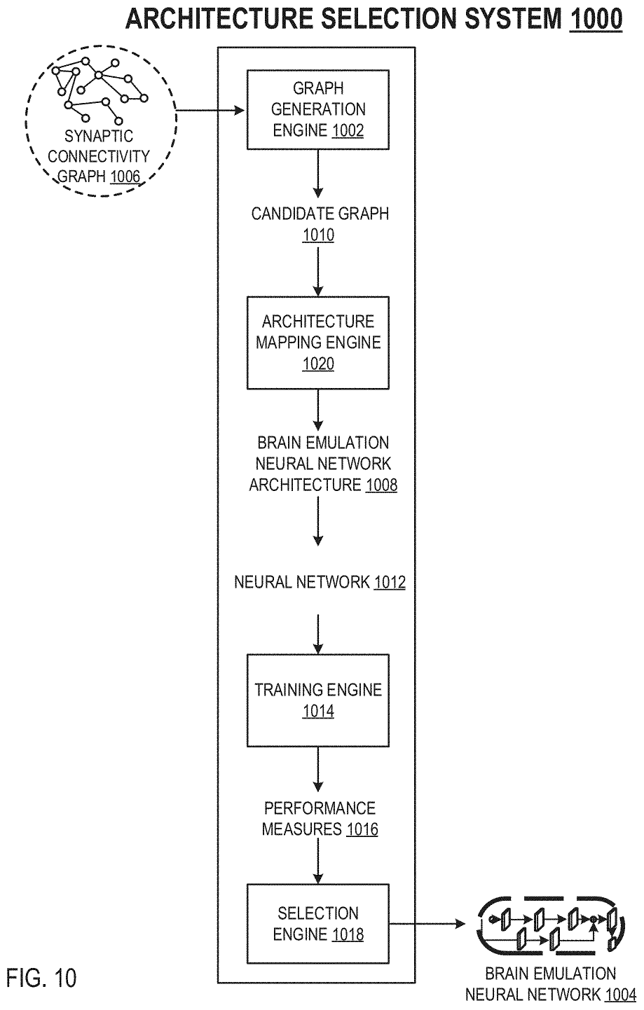

FIG. 10 is an example architecture selection system 1000. The architecture selection system 1000 is an example of a system implemented as computer programs on one or more computers in one or more locations in which the systems, components, and techniques described below are implemented.

The system 1000 is configured to search a space of possible neural network architectures to identify the neural network architecture of a brain emulation neural network 1004 to be included in a neural network (e.g., the network 102 in FIG. 1 or the network 302 in FIG. 3). In some implementations, the system 1000 can identify multiple brain emulation neural networks 1004 to be included in the neural network.

The system 1000 can seed the search through the space of possible neural network architectures using a synaptic connectivity graph 1006 representing synaptic connectivity in the brain of a biological organism. The synaptic connectivity graph 1006 may be derived directly from a synaptic resolution image of the brain of a biological organism, e.g., as described with reference to FIG. 5. In some cases, the synaptic connectivity graph 1006 may be a sub-graph of a larger graph derived from a synaptic resolution image of a brain, e.g., a sub-graph that includes neurons of a particular type, e.g., visual neurons, association neurons.

The system 1000 includes a graph generation engine 1002, an architecture mapping engine 1020, a training engine 1014, and a selection engine 1018, each of which will be described in more detail next.

The graph generation engine 1002 is configured to process the synaptic connectivity graph 1006 to generate multiple “candidate” graphs 1010, where each candidate graph is defined by a set of nodes and a set of edges, such that each edge connects a pair of nodes. The graph generation engine 1002 may generate the candidate graphs 1010 from the synaptic connectivity graph 1006 using any of a variety of techniques. A few examples follow.

In one example, the graph generation engine 1002 may generate a candidate graph 1010 at each of multiple iterations by processing the synaptic connectivity graph 1006 in accordance with current values of a set of graph generation parameters. The current values of the graph generation parameters may specify (transformation) operations to be applied to an adjacency matrix representing the synaptic connectivity graph 1006 to generate an adjacency matrix representing a candidate graph 1010. The operations to be applied to the adjacency matrix representing the synaptic connectivity graph may include, e.g., filtering operations, cropping operations, or both. The candidate graph 1010 may be defined by the result of applying the operations specified by the current values of the graph generation parameters to the adjacency matrix representing the synaptic connectivity graph 1006.

The graph generation engine 1002 may apply a filtering operation to the adjacency matrix representing the synaptic connectivity graph 1006, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 1006 may have the effect of adding edges to the synaptic connectivity graph 1006, removing edges from the synaptic connectivity graph 1006, or both.

The graph generation engine 1002 may apply a cropping operation to the adjacency matrix representing the synaptic connectivity graph 1006, where the cropping operation replaces the adjacency matrix representing the synaptic connectivity graph 1006 with an adjacency matrix representing a sub-graph of the synaptic connectivity graph 1006. Generally, a “sub-graph” may refer to a graph specified by: (i) a proper subset of the nodes of the graph 1006, and (ii) a proper subset of the edges of the graph 1006. The cropping operation may specify a sub-graph of synaptic connectivity graph 1006, e.g., by specifying a proper subset of the rows and a proper subset of the columns of the adjacency matrix representing the synaptic connectivity graph 1006 that define a sub-matrix of the adjacency matrix. The sub-graph may include: (i) each edge specified by the sub-matrix, and (ii) each node that is connected by an edge specified by the sub-matrix.

At each iteration, the system 1000 determines a performance measure 1016 corresponding to the candidate graph 1010 generated at the iteration, and the system 1000 updates the current values of the graph generation parameters to encourage the generation of candidate graphs 1010 with higher performance measures 1016. The performance measure 1016 for a candidate graph 1010 characterizes the performance of a neural network that includes a brain emulation neural network having an architecture specified by the candidate graph 1010 at performing a machine learning task. Determining performance measures 1016 for candidate graphs 1010 will be described in more detail below. The system 1000 may use any appropriate optimization technique to update the current values of the graph generation parameters, e.g., a “black-box” optimization technique that does not rely on computing gradients of the operations performed by the graph generation engine 1002. Examples of black-box optimization techniques which may be implemented by the optimization engine are described with reference to: Golovin, D., Solnik, B Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 1002 may generate the candidate graphs 1010 by “evolving” a population (i.e., a set) of graphs derived from the synaptic connectivity graph 1006 over multiple iterations. The graph generation engine 1002 may initialize the population of graphs, e.g., by “mutating” multiple copies of the synaptic connectivity graph 1006. Mutating a graph refers to making a random change to the graph, e.g., by randomly adding or removing edges or nodes from the graph. After initializing the population of graphs, the graph generation engine 1002 may generate a candidate graph at each of multiple iterations by, at each iteration, selecting a graph from the population of graphs derived from the synaptic connectivity graph and mutating the selected graph to generate a candidate graph 1010. The graph generation engine 1002 may determine a performance measure 1016 for the candidate graph 1010, and use the performance measure to determine whether the candidate graph 1010 is added to the current population of graphs.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

In another example, the graph generation engine 1002 can generate each candidate graph 1010 as a sub-graph of the synaptic connectivity graph 1006. For example, the graph generation engine 1002 can randomly select sub-graphs, e.g., by randomly selecting a proper subset of the rows and a proper subset of the columns of the adjacency matrix representing the synaptic connectivity graph 1006 that define a sub-matrix of the adjacency matrix. The sub-graph may include: (i) each edge specified by the sub-matrix, and (ii) each node that is connected by an edge specified by the sub-matrix.

The architecture mapping engine 1020 processes each candidate graph 1010 to generate a corresponding brain emulation neural network architecture 1008. The architecture mapping engine 1020 may use the candidate graph 1010 derived from the synaptic connectivity graph 1006 to specify the brain emulation neural network architecture 1008 in any of a variety of ways. For example, the architecture mapping engine 1020 may map each node in the candidate graph 1010 to a corresponding: (i) artificial neuron, (ii) artificial neural network layer, or (iii) group of artificial neural network layers in the brain emulation neural network architecture 1008, as will be described in more detail next.

In one example, the brain emulation neural network architecture 1008 can include: (i) a respective artificial neuron corresponding to each node in the candidate graph 1010, and (ii) a respective connection corresponding to each edge in the candidate graph 1010. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the graph.

An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b by executing equation (1) above.

In another example, the candidate graph 1010 can be an undirected graph, and the architecture mapping engine 1020 can map an edge that connects a first node to a second node in the graph to two connections between a corresponding first artificial neuron and a corresponding second artificial neuron in the architecture. In particular, the architecture mapping engine 1020 can map the edge to: (i) a first connection pointing from the first artificial neuron to the second artificial neuron, and (ii) a second connection pointing from the second artificial neuron to the first artificial neuron.

In another example, the candidate graph 1010 can be an undirected graph, and the architecture mapping engine 1020 can map an edge that connects a first node to a second node in the graph to one connection between a corresponding first artificial neuron and a corresponding second artificial neuron in the architecture. The architecture mapping engine 1020 can determine the direction of the connection between the first artificial neuron and the second artificial neuron, e.g., by randomly sampling the direction in accordance with a probability distribution over the set of two possible directions.

In some cases, the edges in the candidate graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain emulation neural network architecture 1008 can include: (i) a respective artificial neural network layer corresponding to each node in the candidate graph, and (ii) a respective connection corresponding to each edge in the candidate graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d by executing equation (2) above. In this example, each convolutional kernel can be represented as an array of numerical values, e.g., where each component of the array is randomly sampled from a predetermined probability distribution, e.g., a standard Normal probability distribution.

In another example, the architecture mapping engine 1020 can determine that the brain emulation neural network architecture includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The architecture of a brain emulation sub-network can directly represent synaptic connectivity in a region of the brain of the biological organism. More specifically, the system can map the nodes of the candidate graph (which each represent, e.g., a biological neuron in the brain) onto corresponding artificial neurons in the brain emulation sub-network. The system can also map the edges of the candidate graph (which each represent, e.g., a synaptic connection between a pair of biological neurons in the brain) onto connections between corresponding pairs of artificial neurons in the brain emulation sub-network. The system can map the respective weight associated with each edge in the candidate graph to a corresponding weight (i.e., parameter value) of a corresponding connection in the brain emulation sub-network. The weight corresponding to an edge (representing, e.g., a synaptic connection in the brain) between a pair of nodes in the candidate graph (representing a pair of biological neurons in the brain) can represent a proximity of the pair of biological neurons in the brain, as described above.

For each brain emulation neural network architecture 1008, the training engine 1014 instantiates a neural network 1012, e.g., the neural network 102 described with reference to FIG. 1, or the neural network 300 described with reference to FIG. 3A. The neural network 1012 can include a brain emulation sub-network that has the brain emulation neural network architecture 1008 and acts as the reservoir. In particular, a neural network can include multiple brain emulation sub-networks. Accordingly, the training engine 1014 can instantiate multiple neural networks 1012 having any appropriate configuration of multiple brain emulation sub-networks. In one example, the training engine 1014 can instantiate a neural network having multiple copies of the same brain emulation sub-network. In another example, the training engine 1014 can instantiate a neural network having multiple different brain emulation sub-networks, e.g., multiple sub-networks that are each specified by a different candidate graph 1010. The training engine 1014 can instantiate any appropriate number and configuration of the neural networks, including any appropriate number and configuration of brain emulation sub-networks, and evaluate each neural network at the same machine learning task, as will be described in more detail next.

Each neural network 1012 is configured to perform a machine learning task, e.g., by processing a network input to generate a corresponding network output that defines a prediction characterizing the network input. The machine learning task can be any appropriate machine learning task, e.g., a classification task, a regression task, a segmentation task, an agent control task, or a combination thereof. The training engine 1014 is configured to train each neural network 1012 over multiple training iterations.

The training engine 1014 determines a respective performance measure 1016 of each neural network 1012 on the machine learning task. For example, the training engine 1014 can train the neural network 1012 on a set of training data over a sequence of training iterations, e.g., using the training engine 316 described with reference to FIG. 3A. The training engine 1014 can then evaluate the performance of the neural network 1012 on a set of validation data, e.g., that includes a set of training examples that are part of the training data used to train the neural network 1012. The training engine 1014 can evaluate the performance of the neural network 1012 on the set of validation data, e.g., by computing an average error (e.g., cross-entropy error or squared-error) in network outputs generated by the neural network for the validation data.

The selection engine 1018 uses the performance measures 1016 to generate the output brain emulation neural network 1004. In one example, the selection engine 1018 may generate a brain emulation neural network 1004 having the brain emulation neural network architecture 1008 associated with the best (e.g., highest) performance measure 1016. The output brain emulation neural network 1004 can then be included in, e.g., the neural network 102 described with reference to FIG. 1.

As described above, the brain emulation neural network architecture can be specified by a synaptic connectivity graph that represents the structure of synaptic connections in the brain of the biological organism. The synaptic connectivity graph can be obtained from a synaptic resolution image of the brain of the biological organism, as is described in more detail above.

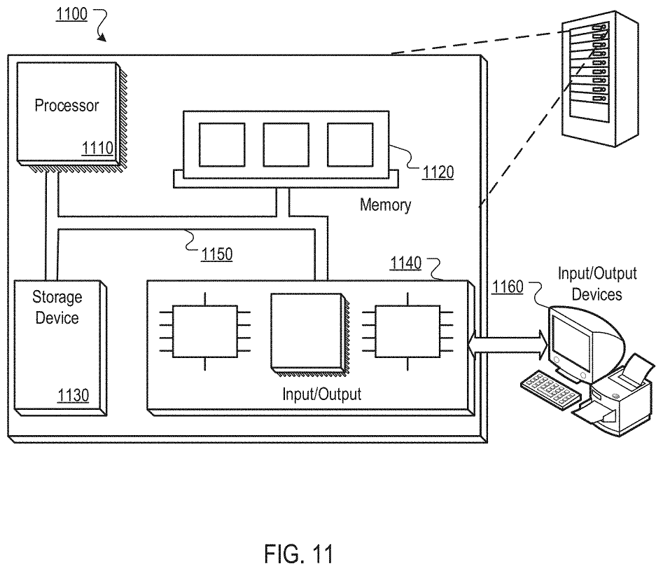

FIG. 11 is a block diagram of an example computer system 1100 that can be used to perform operations described previously. The system 1100 includes a processor 1110, a memory 1120, a storage device 1130, and an input/output device 1140. Each of the components 1110, 1120, 1130, and 1140 can be interconnected, for example, using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 can include, for example, a hard disk device, an optical disk device, a storage device that is shared over a network by multiple computing devices (for example, a cloud storage device), or some other large capacity storage device.

The input/output device 1140 provides input/output operations for the system 1100. In one implementation, the input/output device 1140 can include one or more network interface devices, for example, an Ethernet card, a serial communication device, for example, and RS-232 port, and/or a wireless interface device, for example, and 802.11 card. In another implementation, the input/output device 1140 can include driver devices configured to receive input data and send output data to other input/output devices, for example, keyboard, printer and display devices 1160. Other implementations, however, can also be used, such as mobile computing devices, mobile communication devices, and set-top box television client devices.

Although an example processing system has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by one or more computers, the method comprising: obtaining a network input; and

processing the network input using a neural network to generate a network output, comprising:
generating a layer input to a connectivity layer of the neural network based on the network input, wherein the layer input to the connectivity layer comprises a plurality of input values arranged in a plurality of input channels;
processing the layer input using the connectivity layer to generate a layer output comprising a plurality of output values arranged in a plurality of output channels, wherein the connectivity layer generates each output channel by processing only a respective proper subset of the plurality of input channels;
processing the plurality of output channels of the connectivity layer using a brain emulation subnetwork of the neural network to generate a brain emulation subnetwork output, wherein the brain emulation subnetwork has a brain emulation neural network architecture that comprises a plurality of brain emulation parameters that represent synaptic connectivity between a plurality of biological neurons in a brain of a biological organism; and
generating the network output based on the brain emulation subnetwork output.

Embodiment 2 is the method of embodiment 1, wherein generating each output channel of the connectivity layer comprises:

obtaining the respective proper subset of the plurality of input channels to the connectivity layer;

for each input channel in the proper subset, scaling the input channel by a respective machine-learned value to generate a scaled input channel; and

combining the scaled input channels to generate the output channel.

Embodiment 3 is the method of any one of embodiments 1 or 2, wherein generating a layer input to the connectivity layer based on the network input comprises:

processing the network input using a plurality of neural network layers of the neural network to generate an embedding of the network input; and

determining the plurality of input channels of the layer input to be respective rows, columns, channels, or tiles of the embedding of the network input.

Embodiment 4 is the method of any one of embodiments 1-3, wherein the plurality of brain emulation parameters representing synaptic connectivity between the plurality of biological neurons in the brain of the biological organism are arranged in a two-dimensional weight matrix having a plurality of rows and a plurality of columns,

wherein each row and each column of the weight matrix corresponds to a respective biological neuron from the plurality of biological neurons, and

wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

Embodiment 5 is the method of embodiment 4, wherein each brain emulation parameter of the weight matrix has a respective value that characterizes synaptic connectivity in the brain of the biological organism between the respective pair of biological neurons corresponding to the brain emulation parameter.

Embodiment 6 is the method of embodiment 5, wherein each brain emulation parameter of the weight matrix that corresponds to a respective pair of biological neurons that are not connected by a synaptic connection in the brain of the biological organism has value zero.

Embodiment 7 is the method of any one of embodiments 5 or 6, wherein each brain emulation parameter of the weight matrix that corresponds to a respective pair of biological neurons that are connected by a synaptic connection in the brain of the biological organism has a respective non-zero value characterizing an estimated strength of the synaptic connection.

Embodiment 8 is the method of any one of embodiments 5-7, wherein each brain emulation parameter of the weight matrix that corresponds to a respective pair of biological neurons that are connected by a synaptic connection in the brain of the biological organism has a respective non-zero value that is based on a proximity of the pair of biological neurons in the brain.

Embodiment 9 is the method of any one of embodiments 4-8, wherein:

the brain emulation subnetwork output comprises a plurality of brain emulation channels; and

processing the plurality of output channels of the connectivity layer using the brain emulation subnetwork to generate the brain emulation subnetwork output comprises:
performing a matrix multiplication of: (i) the plurality of output channels of the connectivity layer, and (ii) the two-dimensional weight matrix of brain emulation parameters representing synaptic connectivity between the plurality of biological neurons in the brain of the biological organism.

Embodiment 10 is the method of embodiment 9, wherein:

there are C₁ output channels of the connectivity layer each having dimensionality H×W;

the two-dimensional weight matrix of brain emulation parameters has dimensionality C₁×C₂; and

there are C₂ first channels of the brain emulation subnetwork output each having dimensionality H×W.

Embodiment 11 is the method of any one of embodiments 1-10, wherein the plurality of brain emulation parameters representing synaptic connectivity between the plurality of biological neurons in the brain of the biological organism are determined from a synaptic resolution image of at least a portion of the brain of the biological organism, the determining comprising:

processing the synaptic resolution image to identify: (i) the plurality of biological neurons, and (ii) a plurality of synaptic connections between pairs of biological neurons;

determining a respective value of each brain emulation parameter of the brain emulation subnetwork, comprising:
setting a value of each brain emulation parameter that corresponds to a pair of biological neurons in the brain that are not connected by a synapse to zero; and
setting a value of each brain emulation parameter that corresponds to a pair of biological neurons in the brain that are connected by a synapse based on a proximity of the pair of biological neurons in the brain.

Embodiment 12 is the method of any one of embodiments 1-11, wherein the connectivity layer comprises a plurality connectivity layer parameters that are trained during training of the neural network.

Embodiment 13 is the method of any one of embodiments 1-12, wherein the plurality of brain emulation parameters representing synaptic connectivity between the plurality of biological neurons in the brain of the biological organism are static during training of the neural network.

Embodiment 14 is the method of any one of embodiments 1-13, wherein the brain emulation neural network architecture is determined from a synaptic connectivity graph that represents the synaptic connectivity between the biological neurons in the brain of the biological organism.

Embodiment 15 is the method of embodiment 14, wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

Embodiment 16 is the method of any one of embodiments 14 or 15, wherein determining the brain emulation neural network architecture from the synaptic connectivity graph comprises:

generating data defining a plurality of candidate graphs based on the synaptic connectivity graph;

determining, for each candidate graph, a performance measure on a machine learning task of an instance of a neural network having a brain emulation sub-network with an architecture that is specified by the candidate graph; and

selecting the brain emulation neural network architecture based on the performance measures.

Embodiment 17 is the method of embodiment 16, wherein selecting the brain emulation neural network architectures based on the performance measures comprises:

identifying a best-performing candidate graph that is associated with a highest performance measure from among the plurality of candidate graphs; and

selecting the brain emulation neural network architecture to be an artificial neural network architecture specified by the best-performing candidate graph.

Embodiment 18 is the method of any one of embodiments 1-17, wherein the brain emulation subnetwork output comprises a plurality of brain emulation channels, and wherein generating the network output based on the brain emulation subnetwork output comprises:

processing the plurality of brain emulation channels of the brain emulation subnetwork output using a second connectivity layer to generate a second layer output of the second connectivity layer that comprises a plurality of second output channels,

wherein the second connectivity layer generates each second output channel by processing only a respective proper subset of the plurality of brain emulation channels.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is one or more non-transitory computer storage media encoded with a computer program, the program comprising instructions that are operable, when executed by data processing apparatus, to cause the data processing apparatus to perform the method of any one of embodiments 1 to 18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
obtaining a network input; and
processing the network input using a neural network to generate a network output, comprising:
generating a layer input to a connectivity layer of the neural network based on the network input, wherein the layer input to the connectivity layer comprises a plurality of input values arranged in a plurality of input channels;
processing the layer input using the connectivity layer to generate a layer output comprising a plurality of output values arranged in a plurality of output channels, wherein the connectivity layer generates each output channel by processing only a respective proper subset of the plurality of input channels;
processing the plurality of output channels of the connectivity layer using a brain emulation subnetwork of the neural network to generate a brain emulation subnetwork output, wherein the brain emulation subnetwork has a brain emulation neural network architecture that comprises a plurality of brain emulation parameters that represent synaptic connectivity between a plurality of biological neurons in a brain of a biological organism; and
generating the network output based on the brain emulation subnetwork output.

2. The method of claim 1, wherein generating each output channel of the connectivity layer comprises:
obtaining the respective proper subset of the plurality of input channels to the connectivity layer;
for each input channel in the proper subset, scaling the input channel by a respective machine-learned value to generate a scaled input channel; and
combining the scaled input channels to generate the output channel.

3. The method of claim 1, wherein generating a layer input to the connectivity layer based on the network input comprises:
processing the network input using a plurality of neural network layers of the neural network to generate an embedding of the network input; and
determining the plurality of input channels of the layer input to be respective rows, columns, channels, or tiles of the embedding of the network input.

4. The method of claim 1, wherein the plurality of brain emulation parameters representing synaptic connectivity between the plurality of biological neurons in the brain of the biological organism are arranged in a two-dimensional weight matrix having a plurality of rows and a plurality of columns,
wherein each row and each column of the weight matrix corresponds to a respective biological neuron from the plurality of biological neurons, and
wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

5. The method of claim 4, wherein each brain emulation parameter of the weight matrix has a respective value that characterizes synaptic connectivity in the brain of the biological organism between the respective pair of biological neurons corresponding to the brain emulation parameter.

6. The method of claim 5, wherein each brain emulation parameter of the weight matrix that corresponds to a respective pair of biological neurons that are not connected by a synaptic connection in the brain of the biological organism has value zero.

7. The method of claim 5, wherein each brain emulation parameter of the weight matrix that corresponds to a respective pair of biological neurons that are connected by a synaptic connection in the brain of the biological organism has a respective non-zero value characterizing an estimated strength of the synaptic connection.

8. The method of claim 5, wherein each brain emulation parameter of the weight matrix that corresponds to a respective pair of biological neurons that are connected by a synaptic connection in the brain of the biological organism has a respective non-zero value that is based on a proximity of the pair of biological neurons in the brain.

9. The method of claim 4, wherein:
the brain emulation subnetwork output comprises a plurality of brain emulation channels; and
processing the plurality of output channels of the connectivity layer using the brain emulation subnetwork to generate the brain emulation subnetwork output comprises:
performing a matrix multiplication of: (i) the plurality of output channels of the connectivity layer, and (ii) the two-dimensional weight matrix of brain emulation parameters representing synaptic connectivity between the plurality of biological neurons in the brain of the biological organism.

10. The method of claim 9, wherein:
there are C₁ output channels of the connectivity layer each having dimensionality H×W;
the two-dimensional weight matrix of brain emulation parameters has dimensionality C₁×C₂; and
there are C₂ first channels of the brain emulation subnetwork output each having dimensionality H×W.

11. The method of claim 1, wherein the plurality of brain emulation parameters representing synaptic connectivity between the plurality of biological neurons in the brain of the biological organism are determined from a synaptic resolution image of at least a portion of the brain of the biological organism, the determining comprising:
processing the synaptic resolution image to identify: (i) the plurality of biological neurons, and (ii) a plurality of synaptic connections between pairs of biological neurons;
determining a respective value of each brain emulation parameter of the brain emulation subnetwork, comprising:
setting a value of each brain emulation parameter that corresponds to a pair of biological neurons in the brain that are not connected by a synapse to zero; and
setting a value of each brain emulation parameter that corresponds to a pair of biological neurons in the brain that are connected by a synapse based on a proximity of the pair of biological neurons in the brain.

12. The method of claim 1, wherein the connectivity layer comprises a plurality connectivity layer parameters that are trained during training of the neural network.

13. The method of claim 1, wherein the plurality of brain emulation parameters representing synaptic connectivity between the plurality of biological neurons in the brain of the biological organism are static during training of the neural network.

14. The method of claim 1, wherein the brain emulation neural network architecture is determined from a synaptic connectivity graph that represents the synaptic connectivity between the biological neurons in the brain of the biological organism.

15. The method of claim 14, wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

16. The method of claim 14, wherein determining the brain emulation neural network architecture from the synaptic connectivity graph comprises:
generating data defining a plurality of candidate graphs based on the synaptic connectivity graph;
determining, for each candidate graph, a performance measure on a machine learning task of an instance of a neural network having a brain emulation sub-network with an architecture that is specified by the candidate graph; and
selecting the brain emulation neural network architecture based on the performance measures.

17. The method of claim 16, wherein selecting the brain emulation neural network architectures based on the performance measures comprises:
identifying a best-performing candidate graph that is associated with a highest performance measure from among the plurality of candidate graphs; and
selecting the brain emulation neural network architecture to be an artificial neural network architecture specified by the best-performing candidate graph.

18. The method of claim 1, wherein the brain emulation subnetwork output comprises a plurality of brain emulation channels, and wherein generating the network output based on the brain emulation subnetwork output comprises:
processing the plurality of brain emulation channels of the brain emulation subnetwork output using a second connectivity layer to generate a second layer output of the second connectivity layer that comprises a plurality of second output channels,
wherein the second connectivity layer generates each second output channel by processing only a respective proper subset of the plurality of brain emulation channels.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a network input; and
processing the network input using a neural network to generate a network output, comprising:
generating a layer input to a connectivity layer of the neural network based on the network input, wherein the layer input to the connectivity layer comprises a plurality of input values arranged in a plurality of input channels;
processing the layer input using the connectivity layer to generate a layer output comprising a plurality of output values arranged in a plurality of output channels, wherein the connectivity layer generates each output channel by processing only a respective proper subset of the plurality of input channels;
processing the plurality of output channels of the connectivity layer using a brain emulation subnetwork of the neural network to generate a brain emulation subnetwork output, wherein the brain emulation subnetwork has a brain emulation neural network architecture that comprises a plurality of brain emulation parameters that represent synaptic connectivity between a plurality of biological neurons in a brain of a biological organism; and
generating the network output based on the brain emulation subnetwork output.

20. One or more non-transitory computer storage media storing instructions that when executed by one or more computers cause the one or more computers to perform operations comprising:
obtaining a network input; and
processing the network input using a neural network to generate a network output, comprising:
generating a layer input to a connectivity layer of the neural network based on the network input, wherein the layer input to the connectivity layer comprises a plurality of input values arranged in a plurality of input channels;
processing the layer input using the connectivity layer to generate a layer output comprising a plurality of output values arranged in a plurality of output channels, wherein the connectivity layer generates each output channel by processing only a respective proper subset of the plurality of input channels;
processing the plurality of output channels of the connectivity layer using a brain emulation subnetwork of the neural network to generate a brain emulation subnetwork output, wherein the brain emulation subnetwork has a brain emulation neural network architecture that comprises a plurality of brain emulation parameters that represent synaptic connectivity between a plurality of biological neurons in a brain of a biological organism; and
generating the network output based on the brain emulation subnetwork output.
